(19) United States
(12) Patent Application Publication
(10) Pub. No.: US 2009/0214133 A1
(43) Pub. Date: Aug. 27, 2009

(54) IMAGE PROCESSING DEVICE AND METHOD AND PROGRAM

(76) Inventor: Koji AOYAMA, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/394,318

(22) Filed: Feb. 27, 2009

(30) Foreign Application Priority Data
Feb. 27, 2008 (JP) P2008-045850

(51) Int. Cl. G06K 9/40

(52) U.S. Cl. 382/268

(57) ABSTRACT

An image processing device configured to reduce noise of an image, including: a position control information generating unit configured to calculate a block boundary position for each of blocks and the distance of each pixel from the block boundary position, based on block size information and block boundary initial position, and generate position control information of said pixels; a block noise detecting unit configured to detect block noise feature information at said block boundary position, based on said position control information; and a noise reduction processing unit configured to reduce noise for each of said blocks, based on said block noise feature information.

### CROSS REFERENCES TO RELATED APPLICATIONS

The present invention contains subject matter related to Japanese Patent Application JP 2008-045850 filed in the Japanese Patent Office on Feb. 27, 2008, the entire contents of which are incorporated herein by reference.

### BACKGROUND OF THE INVENTION

1. Field of the Invention

The present invention relates to an image processing device and method, and program, and particularly relates to an image processing device and method, and program which enable reduction of block noise.

2. Description of the Related Art

In the event of decoding encoded image data, noise can occur in the decoded image. For example, in the event of compressing image data with a compression method such as MPEG (Moving Picture Experts Group), an encoder divides the image data into quadrangle blocks made up of multiple pixels, and subjects each divided block to DCT (Discrete Cosine Transform) processing.

Therefore, when the decoder decodes the image data encoded with the MPEG method, with the decoded image data, in principle, a level step occurs at the boundary portions of each block, whereby block noise occurs.

Thus, a technique has been proposed to reduce or remove the block noise (see Japanese Unexamined Patent Application Publication No. 2002-232890). Such a technique to reduce or remove the block noise is generally realized by applying an LPF (Low Pass filter) to a block boundary position with a known block size (8 in the case of MPEG2), and smoothing.

### SUMMARY OF THE INVENTION

However, with a technique such as shown in Japanese Unexamined Patent Application Publication No. 2002-232890, problems have occurred such as the image information being lost by blurring and so forth, or new block distortion occurring by applying smoothing to only the block boundary.

Also, block noise degree and strength greatly differ by image content and compression encoding conditions (such as bit rate), and in the case that block noise strength is strong with a uniform block noise reduction processing, the block noise reduction effect is insufficient, or in the case that block noise strength is weak and little block noise exits, unnecessary effect is expended, thereby losing image information and causing distortion has occurred.

Also, in the case of scaling an image (resolution conversion) based on image data, depending on the influence by scaling or whether the input image data is from an analog signal or a digital signal, the quality of the signal subjected to digital decoding greatly differs, whereby the degree of distortion is not necessarily constant, and further, if the effects to reduce block noise from causes other than the image content and compression encoding conditions are homogeneous, the block noise may not be sufficiently reduced, or conversely necessary image information may be lost.

By controlling the block noise reduction effects for each noise feature at the block boundary, block noise can be reduced from the overall decoded image data, which has been found to be desirable.

According to an embodiment of the present invention, an image processing device configured to reduce noise of an image includes: a position control information generating unit configured to calculate a block boundary position and the distance of each pixel from the block boundary position for each of blocks, based on block size information and block boundary initial position, and generate position control information of the pixels; a block noise detecting unit configured to detect block noise feature information at the block boundary position, based on the position control information; and a noise reduction processing unit configured to reduce noise for each of the blocks, based on the block noise feature information.

The image processing device may further include: a pixel of interest edge detecting unit configured to detect a pixel of interest edge of a pixel of interest in the image; a boundary edge detecting unit configured to detect a boundary edge of a block boundary near the pixel of interest; an edge weight calculating unit configured to calculate edge weight that controls the strength of reduction in the noise, based on the pixel of interest edge and the boundary edge; a processing weight calculating unit configured to calculate processing weight to control the strength of reduction in the noise, based on the block noise feature information; a position weight calculating unit configured to calculate position weight to control the strength of noise reduction processing, based on position information from the block boundary; an edge weight control unit configured to control the pixel of interest based on the edge weight; a processing weight control unit configured to control the pixel of interest based on the processing weight; and a position weight control unit configured to control the pixel of interest based on the position weight.

The pixel of interest edge detecting unit and boundary edge detecting unit may switch the range of pixels used to detect the pixel of interest edge and boundary edge, based on the block size information, respectively.

The block size of the image may be specified as a scaling ratio from a predetermined block size; and wherein the block boundary initial position is specified with an accuracy of less than a pixel.

The block noise detecting unit may further include: a step determining unit configured to determine whether or not the block noise feature information is a step, based on comparison results between a step between pixels at the block boundary position and the average step between periphery pixels around the block boundary position; wherein the block noise feature information is detected as a simple step, based on the step determining results of the step determining unit.

The block noise detecting unit may further include: a step determining unit configured to determine whether or not the block noise feature information is a simple step, based on comparison results between a step between pixels at the block boundary position and the average step between periphery pixels around the block boundary position; a gradation step unit configured to determine whether or not, based on comparison results of a slope of a periphery position of the block boundary position, the periphery portion has the overall same slope, thereby determining whether or not the periphery portion is a gradation step; an isolated point determining unit configured to determine, at the block boundary position, whether or not a block noise feature of the block to which the pixel of interest belongs is an isolated point, based on a comparison between the difference of the pixel of interest and the peripheral pixels around the pixel of interest and a predetermined threshold, and on a combination of positive/negative signs of the difference; and a texture determining unit configured to determine, at the block boundary position, whether or not the block noise feature is texture imbalance wherein pattern component peaks are collected, based on a combination of positive/negative signs of the difference; wherein the block noise feature information may be detected based on the determination results of the step determining unit, the gradation step unit, the isolated point determining unit, and texture determining unit.

The noise reduction unit may further include: a step correcting unit configured to correct a step at the block boundary position according to the distance from the block boundary position to the pixel of interest in the case that the block noise feature information is a gradation step; a removal correcting unit configured to remove the isolated point and perform correction at the block boundary position in the case that the block noise feature formation is the isolated point; a first smoothing unit configured to smooth the block that includes the pixel of interest at the block boundary position in the case that the block noise feature information is the texture imbalance; and a second smoothing unit configured to smooth the block that includes the pixel of interest at the block boundary position, with a different strength than used with the first smoothing unit in the case that the block noise feature information is the simple step.

The block noise feature information detecting unit may select nearby pixels to use for detecting, based on the block size information.

The noise reducing unit may switch reduction processing, based on the block size information.

According to an embodiment of the present invention, an image processing method of an image processing device configured to reduce noise of an image includes the steps of: position control information generating arranged to calculate a block boundary position for each of blocks and the distance of each pixel from the block boundary position, based on block size information and block boundary initial position, and generate position control information of the pixels; block noise detecting arranged to detect block noise feature information at the block boundary position, based on the position control information; and noise reduction processing arranged to reduce noise for each of the blocks, based on the block noise feature information.

According to an embodiment of the present invention, a program to cause a computer to execute control of an image processing device configured to reduce noise of an image includes the steps of: position control information generating arranged to calculate the block boundary position for each of blocks and the distance of each pixel from the block boundary position, based on block size information and block boundary initial position, and generate position control information of the pixels; block noise detecting arranged to detect block noise feature information at the block boundary position, based on the position control information; and noise reduction processing arranged to reduce noise for each of the blocks, based on the block noise feature information.

A program storage medium according to the present invention may be configured to store the program described above.

According to an embodiment of the present invention, an image processing device configured to reduce noise of an image calculates block boundary position for each block and the distance from the block boundary position of each pixel, based on the block size information and block boundary initial position, whereby the position control information of the pixel is generated, block noise feature information at the block boundary position is detected based on the position control information, and noise is reduced for each block based on the block noise feature information.

According to the above configuration, block noise generated at the time of encoded image data being decoded can be reduced.

### BRIEF DESCRIPTION OF THE DRAWINGS

FIG. 1 is a diagram illustrating a configuration example according to an image processing device to which an embodiment of the present invention is applied;

FIG. 2 is a diagram illustrating an example of image resolution subjected to block noise reduction processing by the image processing device in FIG. 1;

FIG. 3 is a diagram illustrating a configuration example according to an embodiment of the block nose reduction processing unit in FIG. 1;

FIG. 4 is a diagram illustrating a configuration example of a position control unit in FIG. 3;

FIG. 5 is a diagram illustrating a configuration example of an edge detecting unit in FIG. 3;

FIG. 6 is a diagram illustrating a configuration example of a block noise detecting unit in FIG. 3;

FIG. 7 is a diagram illustrating a configuration example of a noise reduction processing unit in FIG. 3;

FIG. 8 is a diagram illustrating a configuration example of a processing weight control unit in FIG. 3;

FIG. 9 is a diagram illustrating a configuration example of an edge weight control unit in FIG. 3;

FIG. 10 is a diagram illustrating a configuration example according to an embodiment of a position weight control unit in FIG. 3;

FIG. 11 is a flowchart describing block noise reduction processing;

FIG. 12 is a flowchart describing position control information generation processing;

FIG. 13 is a diagram illustrating position control information generation processing;

FIG. 14 is a diagram illustrating position control information generation processing;

FIG. 15 is a flowchart describing edge detection processing;

FIG. 16 is a diagram illustrating edge detection processing;

FIG. 17 is a flowchart describing block noise detection processing;

FIG. 18 is a diagram illustrating block noise detection processing;

FIG. 19 is a diagram illustrating block noise detection processing;

FIG. 20 is a flowchart describing noise reduction processing;

FIG. 21 is a diagram illustrating noise reduction processing;

FIG. 22 is a flowchart describing processing weight control processing;

FIG. 23 is a diagram illustrating processing weight control processing;

FIG. 24 is a flowchart describing edge weight control processing;

FIG. 25 is a flowchart describing position weight control processing;

FIG. 26 is a diagram illustrating position weight control processing;

FIG. 27 is a diagram illustrating position weight control processing;

FIG. 28 is a diagram illustrating position weight control processing; and

FIG. 29 is a diagram illustrating a configuration example of a general-use personal computer.

### DESCRIPTION OF THE PREFERRED EMBODIMENTS

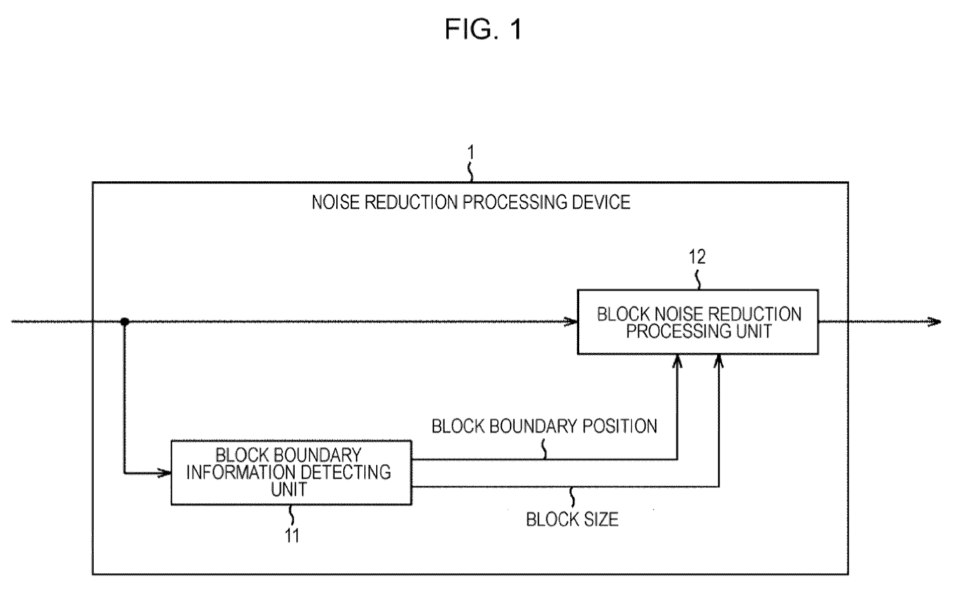

FIG. 1 is a diagram illustrating a configuration example of an image processing device to which an embodiment of the present invention is applied. An image processing device 1 in FIG. 1 is made up of a block boundary information detecting unit 11 and block noise reduction processing unit 12, and controls the noise reduction level for each feature of noise in the block boundaries of an input image, and outputs an image with reduced block noise.

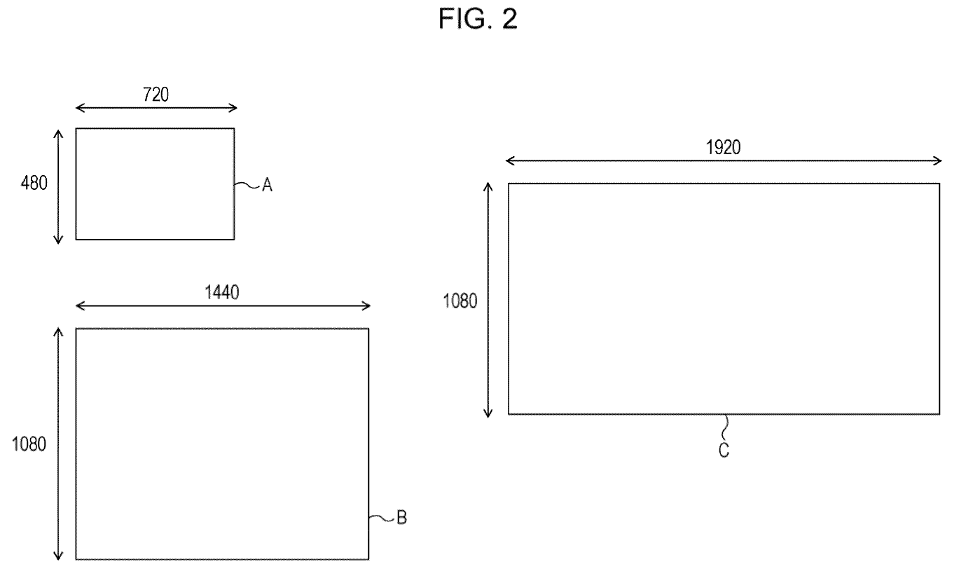

The image input to the image processing device 1 is read out from a recording medium such as a DVD (Digital Versatile Disc) or HDD (Hard Disc Drive) by a player or the like, and includes an image or the like output by being decoded. Of these players, a portion of players have an image enlarging function whereby, for example, even if the recorded image data is image data of an SD (Standard Definition) resolution such as 720 pixels×480 pixels indicating by image A in FIG. 2, this can be converted to an HD (Hi Definition) resolution of 1920 pixels×1080 pixels which has output resolution such as shown in image C, and can be output. Also, in the case that the recording signal is an HD signal, a signal exists of a resolution of 1440 pixels×1080 pixels such as shown in image B, and with a portion of players, the image data in such image B can be converted to the image C with the HD resolution of 1920 pixels×1080 pixels and output.

Accordingly, the image input to the image processing device 1 may be image data wherein analog signals are subjected to analog digital conversion, or may be image data made up of digital signals, or may be an image subjected to resolution conversion (scaling) as to original image data with one of the resolutions as described above.

The block boundary information detecting unit 11 detects a block size which is the increment subjected to DCT (Discrete Cosine Transform) in a state of being encoded before the decoding with the input image, and block boundary position, and supplies the information of each to the block noise reduction processing unit 12 as block size information and block boundary position information.

The block noise reduction processing unit 12 subjects the input image to processing to reduce the noise appropriately for each feature of the noise in the pixels at the block boundary position, based on information of the block size and block boundary position which is supplied by the block boundary information detecting unit 11, and outputs an image with reduced block noise.

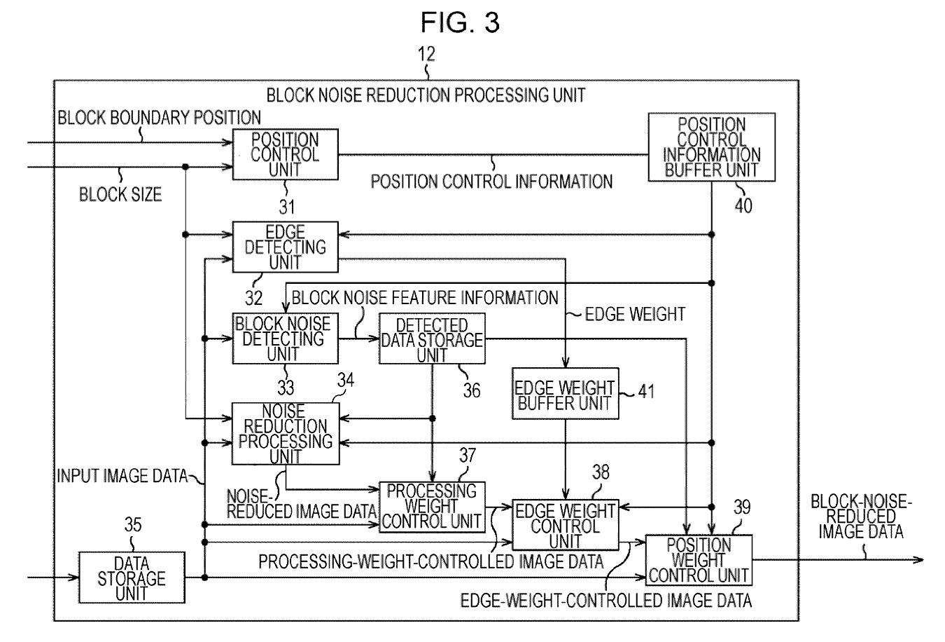

Next, a configuration example of the block noise reduction processing unit 12 according to an embodiment will be described with reference to FIG. 3.

The block noise reduction processing unit 12 is made up of a position control unit 31, edge detecting unit 32, block noise detecting unit 33, noise reduction processing unit 34, data storage unit 35, detected data buffer unit 36, processing weight control unit 37, edge weight control unit 38, position weight control unit 39, position control information buffer unit 40, and edge weight buffer unit 41.

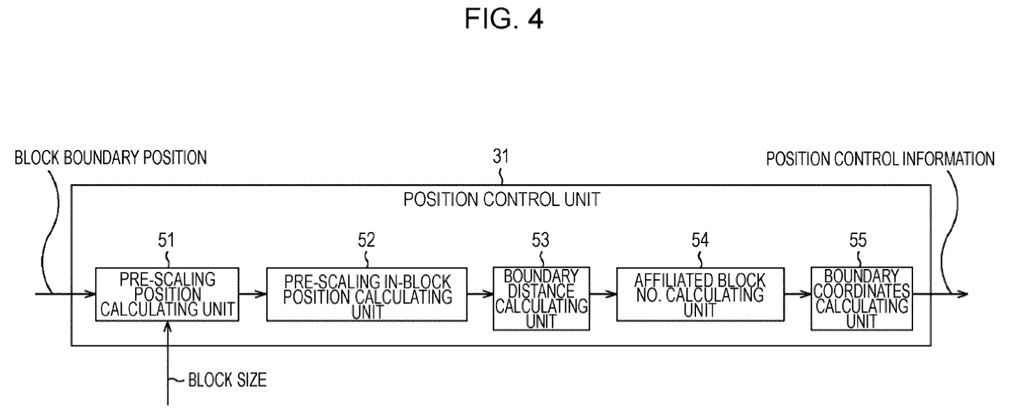

The position control unit 31 calculates the current processing position, i.e. pixel at a position before scaling of the pixel subject to processing (hereafter also called pixel of interest), position within block before scaling, distance to block boundary before scaling, currently belonging block number, and currently closest block boundary position, and stores this as position control information in the position control information buffer unit 40. The position control information is read by the edge detecting unit 32, block noise detecting unit 33, noise reduction processing unit 34, edge weight control unit 38, and position weight control unit 39, and is used for various types of processing. Note that the detailed configuration of the position control unit 31 will be described later with reference to FIG. 4.

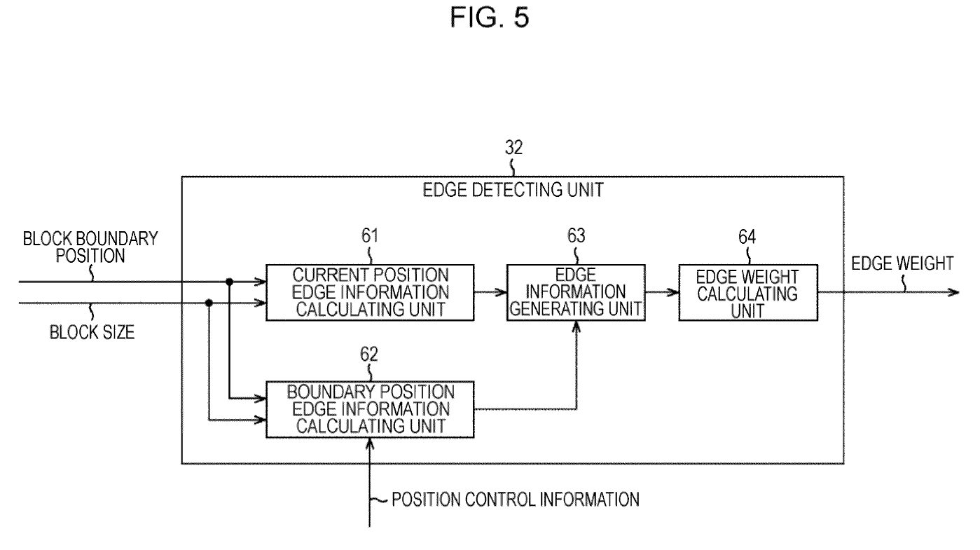

The edge detecting unit 32 reads image data from the data storage unit 35 which holds input image data in a storage array such as a register or memory, and obtains edge strength based on the position control information and block size information, computes edge weight from the edge strength thereof, and stores this in the edge weight buffer unit 41. Note that detailed configuration of the edge detecting unit 32 will be described later with reference to FIG. 5.

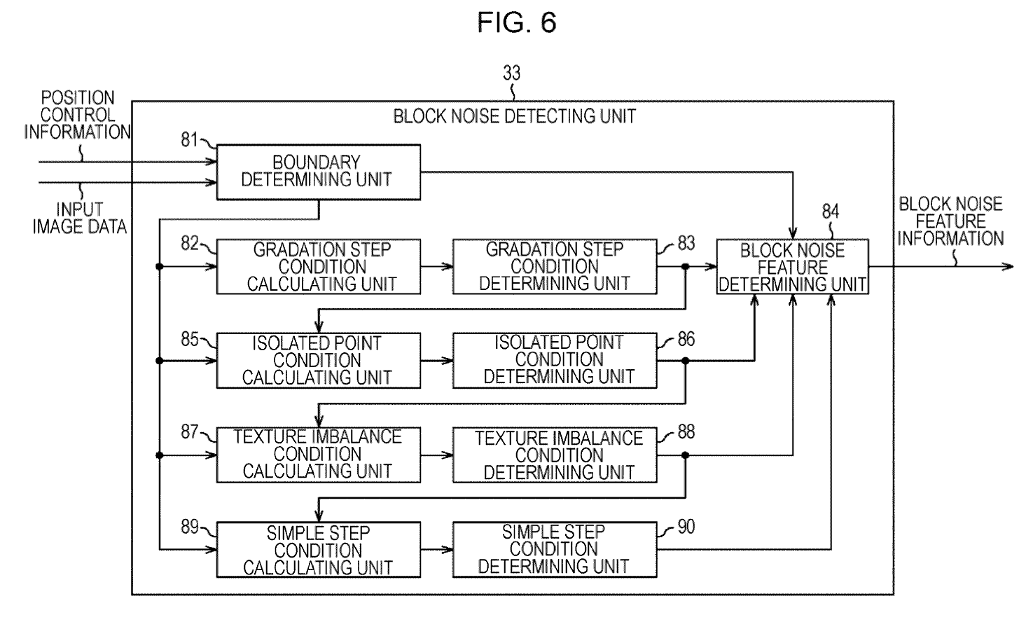

The block noise detecting unit 33 reads input image data from the data storage unit 35 which holds input image data in a storage array such as a register or memory, supplies feature information of the block noise for each pixel at the block boundary position based on the position control information and block size information, as block noise feature information, and stores this in the detected data buffer unit 36 made up of a storage array such as a register and memory. Note that the detailed configuration of the block noise detecting unit 33 will be described later with reference to FIG. 6.

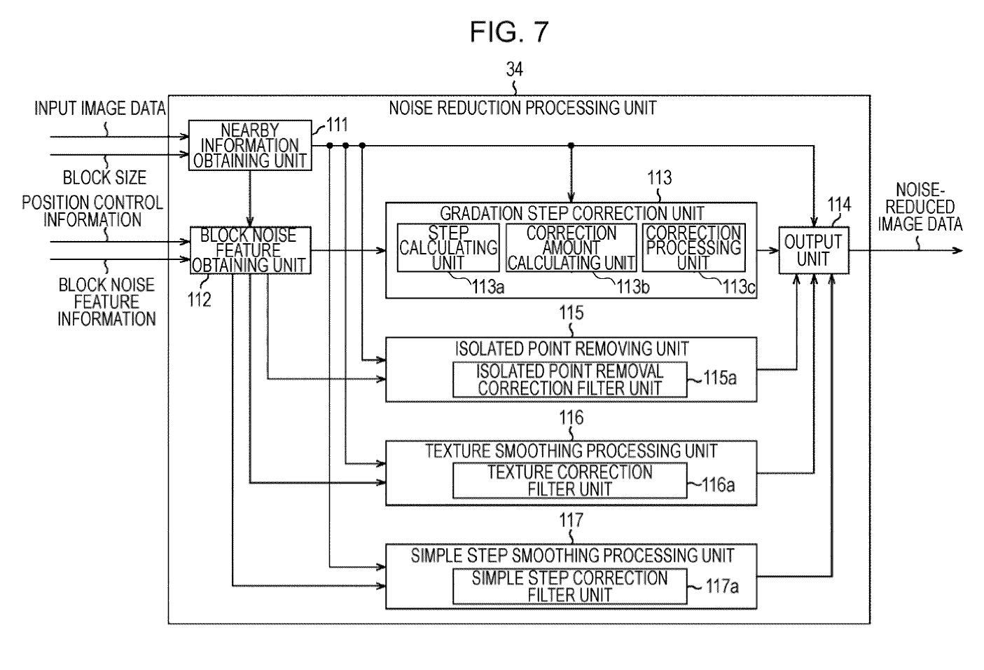

The noise reduction processing unit 34 reads the block noise feature information stored in the detected data buffer unit 36, performs noise reduction processing corresponding to the block noise feature information, and supplies the noise-reduced image data to the processing weight control unit 37. Note that the detailed configuration of the noise reduction processing unit 34 will be described later with reference to FIG. 7.

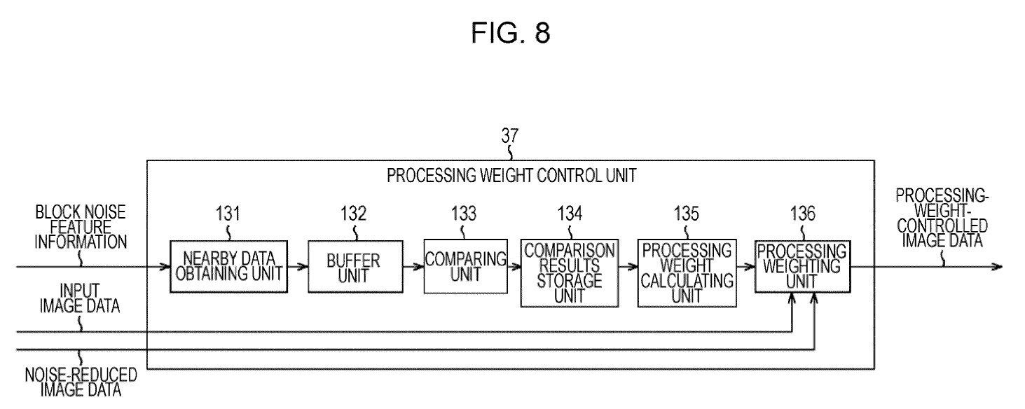

The processing weight control unit 37 calculates the processing weight from a series of block noise feature information stored in the detected data buffer unit 36, and based on the calculated processing weight, synthesizes the input image data read from the data storage unit 35 and the noise-reduced image data subjected to reduction processing with the noise reduction processing unit 34, and supplies this as processing weight controlled image data to the edge weight control unit 38. Note that the detailed configuration of the processing weight control unit 37 will be described with reference to FIG. 8.

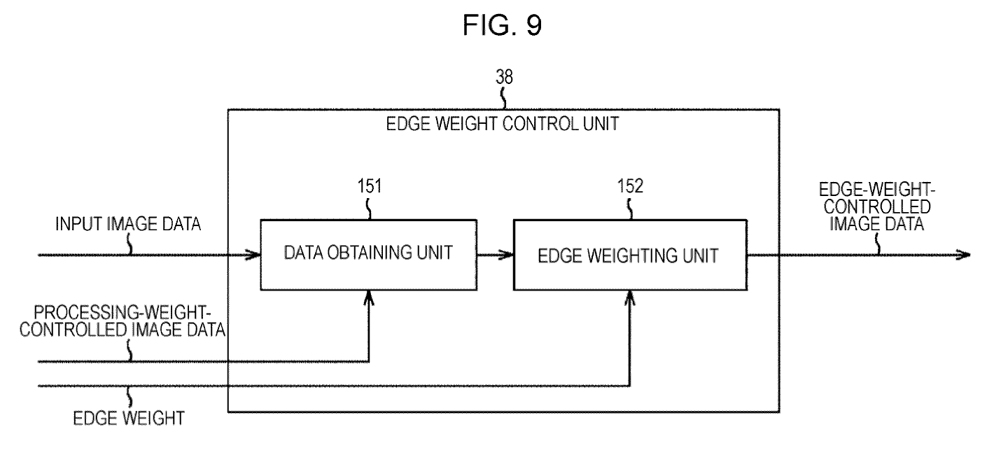

The edge weight control unit 38 reads the edge weight from the edge weight buffer unit 41, and based on the position control information, synthesizes the input image data stored in the data storage unit 35 and the processing weight controlled image data, and supplies this as edge weight controlled image to the position weight control unit 39. Note that the detailed configuration of the edge weight control unit 38 will be described later with reference to FIG. 9.

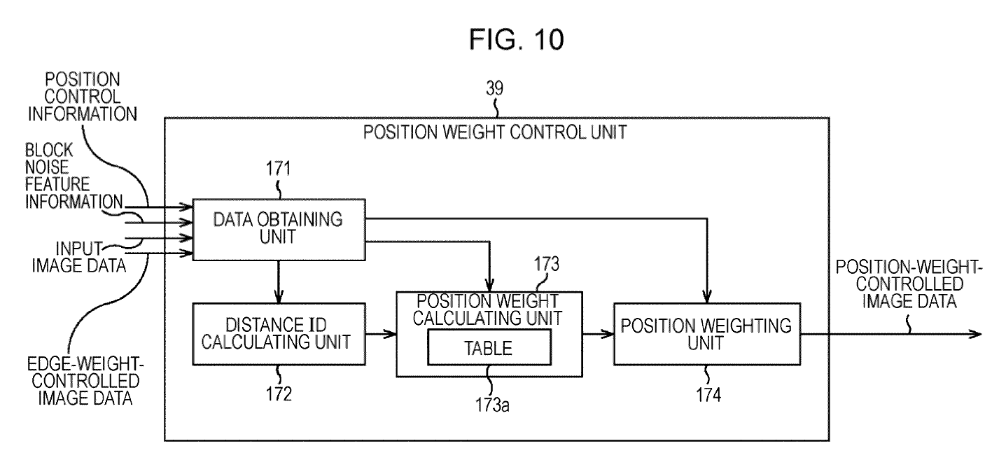

The position weight control unit 39 calculates position weight from the position information within the block of the position control information, and based on the calculated position weight, synthesizes the input image data read from the data storage unit 35 and the edge weight controlled image data supplied from the edge weight control unit 38, and outputs this as a block ncise reduction processing image. Note that the detailed configuration of the position weight control unit 39 will be described later with reference to FIG. 10.

Next, a detailed configuration example of the position control unit 31 will be described with reference to FIG. 4.

The position control unit 31 has a pre-scaling position calculating unit 51, pre-scaling in-block position calculating unit 52, boundary distance calculating unit 53, affiliated block number calculating unit 54, and boundary coordinate calculating unit 55.

The pre-scaling position calculating unit 51 calculates the pixel position before scaling for each pixel, based on the block boundary position information and block size information, and supplies this along with the block boundary position information and block size information to the pre-scaling in-block position calculating unit 52.

The pre-scaling in-block position calculating unit 52 calculates the position of each pixel within the block before scaling, based on pre-scaling position information, block boundary position information, and block size information, and supplies this, along with the block boundary position information and block size information to the boundary distance calculating unit 53.

The boundary distance calculating unit 53 calculates the distance (number of pixels) to the closest block boundary position for each pixel, based on the in-block position information, pre-scaling position information, block boundary position information, and block size information, and supplies the calculation results, along with the block boundary position information and block size information to the affiliated block number calculating unit 54.

The affiliated block number calculating unit 54 calculates the block number to which each pixel belongs, based on the information of the distance of each pixel to the closest block boundary position, in-block position information, pre-scaling position information, block boundary position information, and block size information, and supplies the block number, along with the distance to the closest block boundary position, block boundary position information, and block size information, to the boundary coordinate calculating unit 55.

The boundary coordinate calculating unit 55 calculates the coordinates of the closest block boundary position for the post-scaling image data, based on the block number, the distance information to the closest block boundary position from the current position for each pixel, in-block position information, pre-scaling position information, block boundary position information, and block size information, and stores the block number, distance information to the closest block boundary position from the current position for each pixel, in-block position information, pre-scaling position information, block boundary position information, and block size information, as position control information in the position control information buffer unit 40.

Next, a detailed configuration example of the edge detecting unit 32 will be described with reference to FIG. 5.

The edge detecting unit 32 has a current position edge information calculating unit 61, boundary position edge information calculating unit 62, edge information generating unit 63, and edge weight calculating unit 64.

The current position edge information calculating unit 61 calculates edge information ed_x for each pixel, and supplies this to the edge information generating unit 63.

The boundary position edge information calculating unit 62 calculates edge information ed_b for a pixel at a nearby block boundary position for each pixel, and supplies this to the edge information generating unit 63.

The edge information generating unit 63 compares the edge information ed_x and ed_b, and supplies the greater value of the two as edge information ed_max to the edge weight calculating unit 64.

The edge weight calculating unit 64 calculates edge weight edwgt, based on the edge information ed_max, and stores this in the edge weight buffer unit 41.

Next, a detailed configuration example of the block noise detecting unit 33 will be described with reference to FIG. 6.

The block noise detecting unit 33 has a boundary determining unit 81, gradation step condition calculating unit 82, gradation step condition determining unit 83, block noise feature determining unit 84, isolated point condition calculating unit 85, isolated point condition determining unit 86, texture imbalance condition calculating unit 87, texture imbalance condition determining unit 88, simple step condition calculating unit 89, and simple step condition determining unit 90.

The boundary determining unit 81 determines whether or not the position of the pixel subject to processing satisfies the condition for a block boundary, based on the position control information and block size information, and supplies the determination results to the gradation step condition calculating unit 82 and block noise feature determining unit 84.

Upon determination results indicating that the pixel subject to processing is for a boundary is input from the boundary determining unit 81, the gradation step condition calculating unit 82 calculates a gradation step condition expression indicating change to the pixel values at the block boundary from the pixel values between a pixel of interest and the pixels of the periphery pixels around the pixel interest, from the input image data, and supplies the calculation results to the gradation step condition determining unit 83.

The gradation step condition determining unit 83 determines whether or not there is any gradation step, based on the calculation results of the gradation step conditions, and supplies the determination results to the block noise feature determining unit 84 and isolated point condition calculating unit 85.

The block noise feature determining unit 84 determines whether the block noise feature is one of gradation step, isolated point, texture imbalance, simple step, or no noise, based on the determination results from the boundary determining unit 81, gradation step condition determining unit 83, isolated point condition determining unit 86, texture imbalance condition determining unit 88, and simple step condition determining unit 90, and stores the determination results, as block noise feature information, in the detected data buffer unit 36.

In the case that the determination results of the gradation step condition determining unit 83 do not indicate gradation step, the isolated point condition calculation unit 85 calculates an isolated point condition expression, showing that the change in pixel values between the pixels of the pixel of interest and the peripheral pixels around the pixel of interest is an isolated point, from the input image data, and supplies the calculation results to the isolated point condition determining unit 86.

The isolated point condition determining unit 86 determines whether or not the pixel subject to processing is an isolated point, based on the calculation results of the isolated point condition expression, and supplies the determination results to the block noise feature determining unit 84 and texture imbalance condition calculating unit 87.

In the case that the determination results of the isolated point condition calculation unit 85 do not indicate an isolated point, the texture imbalance condition calculating unit 87 calculates a texture imbalance condition expression indicating that an specific amplitude component is included in the peripheral pixels around the pixel of interest, from the input image data, and supplies the calculation results to the texture imbalance condition determining unit 88.

The texture imbalance condition determining unit 88 determines whether or not any texture imbalance is occurring in the periphery of the pixels subject to processing, based on the calculation results of the texture imbalance conditions, and supplies the determination results to the block noise feature determination unit 84 and simple step condition calculating unit 89.

In the case that the determination results of the texture imbalance condition determining unit 88 do not indicate texture imbalance, the simple step condition calculating unit 89 calculates a simple step condition expression indicating that a simple step has occurred in the peripheral pixels around the pixel interest, from the input image data, and supplies the calculation results to the simple step condition determining unit 90.

The simple step condition determining unit 90 determines whether or not any simple step has occurred in the periphery of the pixels subject to processing, based on the calculation results of the simple step condition, and supplies the determination results to the block noise feature determining unit 84.

Next, a detailed configuration example of the noise reduction processing unit 34 will be described with reference to FIG. 7.

The noise reduction processing unit 34 has a nearby information obtaining unit 111, block noise feature information obtaining unit 112, gradation step correcting unit 113, output unit 114, isolated point removing unit 115, texture smoothing processing unit 116, and simple step smoothing processing unit 117.

The nearby information obtaining unit 111 extracts image information from near the pixel of interest, based on the input image data and block size information.

The block noise feature information obtaining unit 112 obtains block noise feature information, based on position control information, and supplies the block noise feature information and block number information to the gradation step correcting unit 113, isolated point removing unit 115, texture smoothing processing unit 116, or simple step smoothing processing unit 117 based on the obtained block noise feature information.

The gradation step correcting unit 113 has a step calculating unit 113a, correction amount calculating unit 113b, and correction processing unit 113c, and upon the block noise feature information indicating a gradation step being supplied from the block noise feature information obtaining unit 112, the gradation step is corrected using the pixels wherein information of nearby pixels of the corresponding block number is supplied by the nearby information obtaining unit 111, employing the step calculating unit 113a, correction amount calculating unit 113b, and correction processing unit 113c, and the pixels are supplied to the output unit 114.

The isolated point removing unit 115 has an isolated point removal correction filter unit 115a, and upon block noise feature information indicating an isolated point being supplied by the block noise feature information obtaining unit 112, isolated point removal correcting is performed using the pixels wherein information of nearby pixels of the corresponding block number is supplied by the nearby information obtaining unit 111, employing the isolated point removal correction filter unit 115a, and the pixels are supplied to the output unit 114.

The texture smoothing processing unit 116 has a texture correction filter unit 116a, and upon block noise feature information indicating texture imbalance being supplied from the block noise feature information obtaining unit 112, texture smoothing correction is performed using the pixels wherein information of nearby pixels of the corresponding block number is supplied by the nearby information obtaining unit 111, employing the texture correction filter unit 116a, and the pixels are supplied to the output unit 114.

The simple step smoothing processing unit 117 has a simple step correction filter unit 117a, and upon block noise feature information indicating a simple step being supplied from the block noise feature information obtaining unit 112, simple step smoothing correction is performed using the pixels wherein information of nearby pixels of the corresponding block number is supplied by the nearby information obtaining unit 111, employing the simple step correction filter unit 117a, and the pixels are supplied to the output unit 114.

The output unit 114 outputs the corrected pixels supplied from the gradation step correcting unit 113, isolated point removing unit 115, texture smoothing processing unit 116, and simple step smoothing processing unit 117 as reduced-noise image data.

Next, a detailed configuration example of the processing weight control unit 37 will be described with reference to FIG. 8.

The processing weight control unit 37 has a nearby data obtaining unit 131, buffer unit 132, comparing unit 133, comparison results storage unit 134, processing weight calculating unit 135, and processing weighting unit 136.

The nearby data obtaining unit 131 obtains block noise feature information of the periphery pixels including the pixel of interest from the detected data buffer unit 36, and stores this in the buffer unit 132.

The comparing unit 133 compares the block noise feature information of the pixel of interest and the nearby pixels thereof based on the pixel information stored in the buffer unit 132, and stores the comparison results in the comparison results storage unit 134.

The processing weight calculating unit 135 calculates processing weight, based on the comparison results of the block noise feature information of the pixel of interest and the nearby pixels thereof stored in the comparison results storage unit 134, and supplies this to the processing weighting unit 136.

The processing weighting unit 136 uses the processing weight supplied from the processing weight calculating unit 135 to synthesize the reduced-noise image data supplied from the noise reduction processing unit 34 and the input image data, and generates processing weight control image data and supplies this to the edge weight control unit 38.

Next, a detailed configuration example of the edge weight control unit 38 will be described with reference to FIG. 9. The edge weight control unit 38 has a data obtaining unit 151 and edge weighting unit 152. The data obtaining unit 151 obtains input image data and processing weight control image data, and supplies this to the edge weighting unit 152. The edge weighting unit 152 synthesizes the input image data and processing weight control image data, based on the edge weight stored in the edge weight buffer unit 41, and supplies this as edge weight control image data to the position weight control unit 39.

Next, a detailed configuration example of the position weight control unit 39 will be described with reference to FIG. 10. The position weight control unit 39 has a data obtaining unit 171, a distance ID calculating unit 172, position weight calculating unit 173, and position weighting unit 174.

The data obtaining unit 171 obtains position control information, block noise feature information, input image data, and edge-weight-controlled image data, supplies the position control information to the distance ID calculating unit 172, supplies the block noise feature information to the position weight calculating unit 173, and supplies the input image data and edge-weight-controlled image data to the position weighting unit 174.

The distance ID calculating unit 172 obtains a distance ID from the block boundary position of the pixel of interest from the position control information, and supplies this to the position weight calculating unit 173.

The position weight calculating unit 173 reads the position weight which is registered beforehand in a table 173a, based on the block noise feature information of the pixel of interest, and the distance ID within the block of the pixel of interest, and determines and supplies the position weight to the position weighting unit 174.

The position weighting unit 174 synthesizes the input image data and edge-weight-controlled image data, based on the position weight supplied by the position weight calculating unit 173, and generates and outputs position-weight-controlled image data.

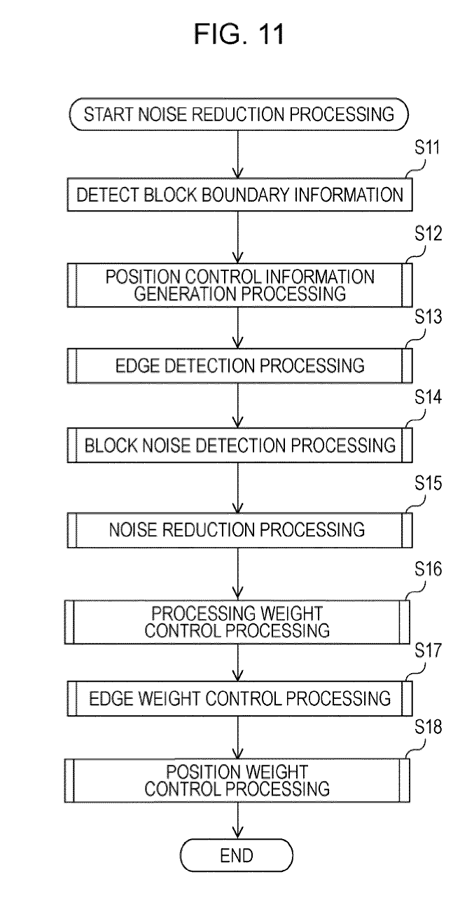

Next, the block noise reduction processing with the image processing device in FIG. 1 will be described with reference to the flowchart in FIG. 11. Note that with this processing, each pixel in the input image data is subject to noise reduction processing, but the description here is given for an example wherein noise reduction processing is performed for one line worth of pixels in the horizontal direction, and processing is repeated similarly as to the pixels in the other lines in sequence, for the number of lines worth. However, as a matter of course, processing may be performed one row at a time in the vertical direction, or may be processing in a different direction in another sequence.

In step S11, the block boundary information detecting unit 11 detects block size 64/block_ratio and block boundary position block_pos which are processing increments in the DCT processing for the image prior to the input image data being subject to scaling, and supplies these to the block noise reduction processing unit 12.

If we say that the pre-scaling pixel is 1, the block boundary position block_pos can specify a size expressing a size less than the pixel with a precision of 1/64 pixel as the minimum increment of the coordinate. Accordingly, for example in the case that the pre-scaling horizontal resolution is 1440 pixels, whereas the post-scaling horizontal resolution is 1920 pixels, the pre-scaling pixel size is expressed as 64 (minimum increment) whereas the post-scaling pixel size is expressed as 48 (minimum increment), and similarly for the block size also, the same ratios hold. That is to say, in this case, the block size ratio block_ratio with the input image data is expressed as 48. In other words, the pre-scaling block size becomes 1.333 (= 64/48) times the post-scaling block size (the block size for the input image data). Hereafter, let us say that the value of the coordinate position having no particular increment for a numerical value, or the size display, has a minimum increment of 1/64 pixel when the pixel size of the pre-scaling image data is 1.

In this example, the minimum increment is described as precision of 1/64 pixel when the pre-scaling pixel size is 1, but the minimum increment for precision can be arbitrarily selected. Also, the minimum increment for precision may be calculated with a floating point.

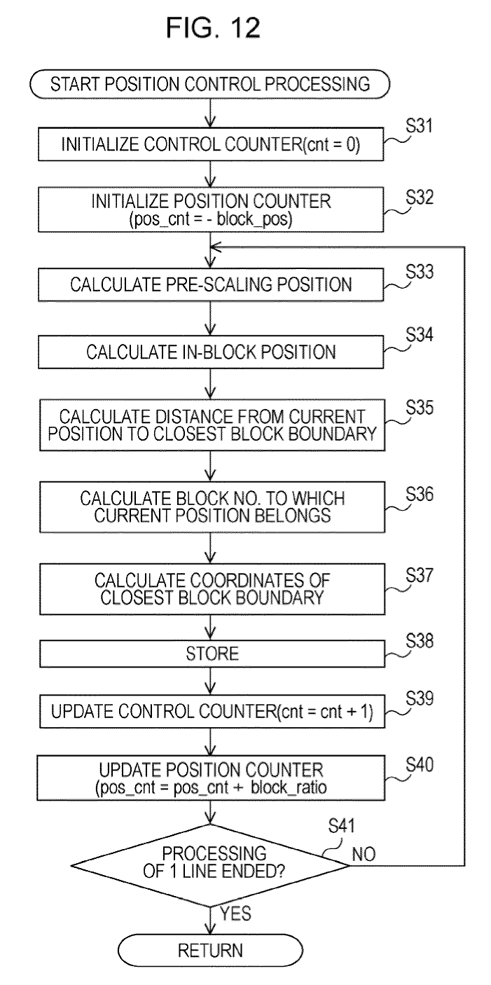

In step S12, the block noise reduction processing unit 12 controls the position control unit 31 to execute position control information generation processing, generates position control information, and stores this in the position control information buffer unit 40. Note that the position control information generation processing will be described in detail later with reference to FIG. 12.

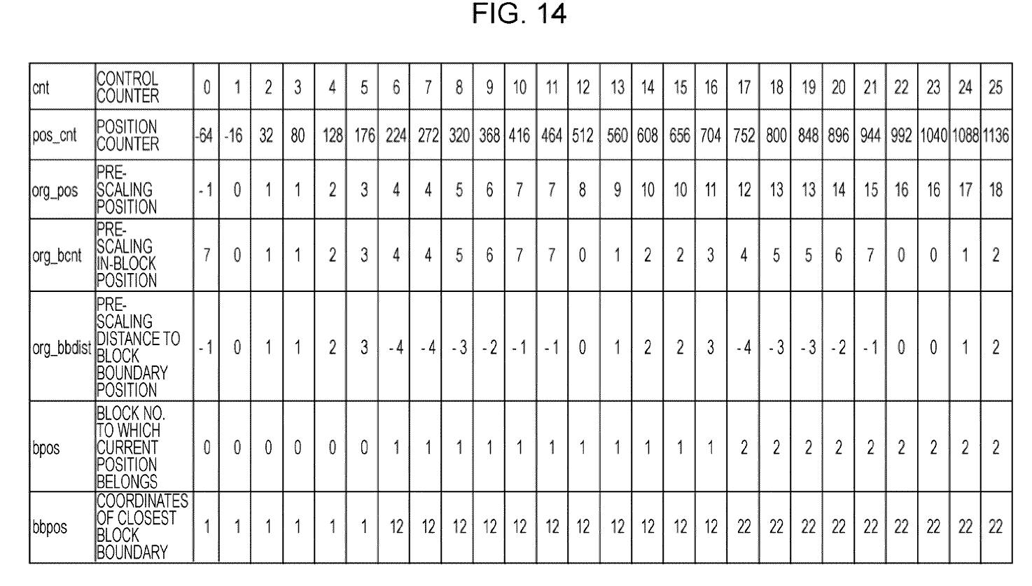

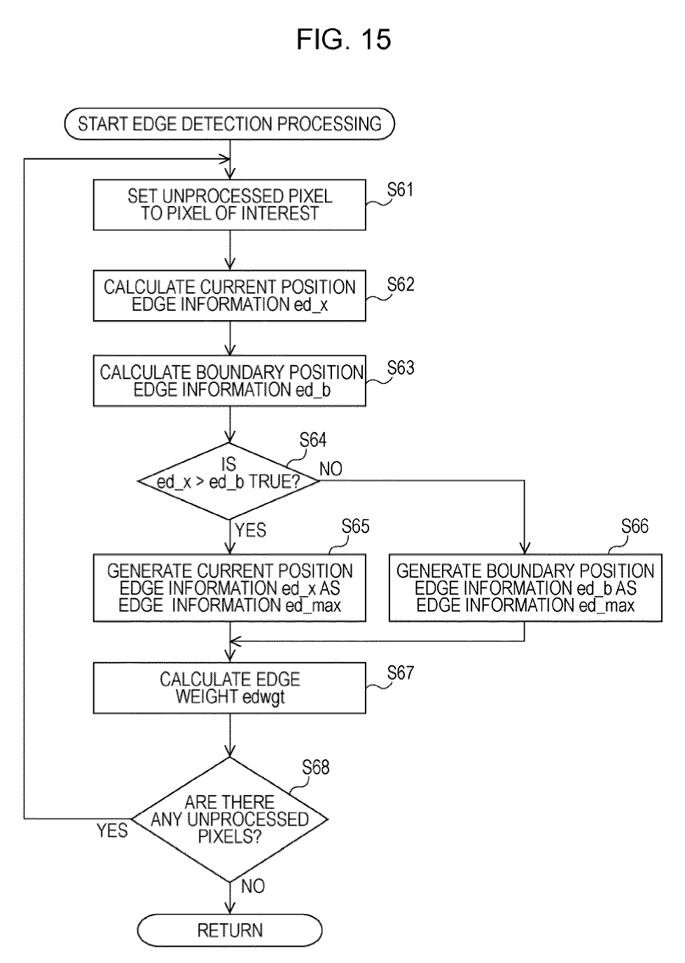

In step S13, the edge detecting unit 32 executes edge detection processing, based on input image data and block size information, detects an edge, generates edge weight edwgt, and stores this in the edge weight buffer unit 41. Note that the edge detection processing will be described in detail later with reference to FIG. 15.

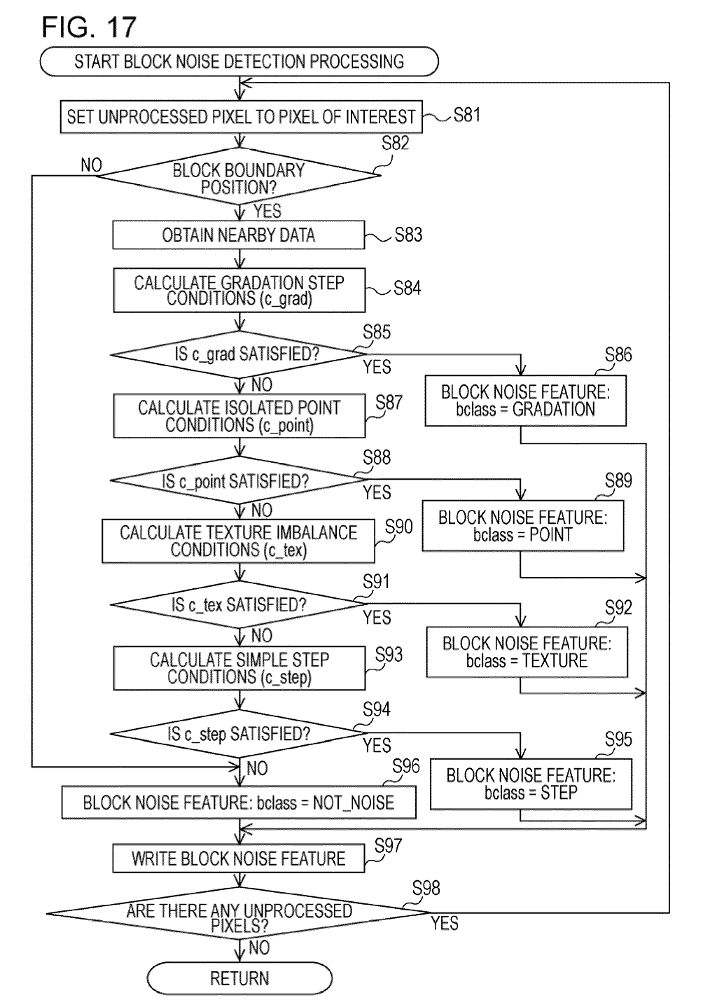

In step S14, the block noise detecting unit 33 executes block noise detection processing, based on input image data and position control information, detects block noise for the pixels at the block boundary position, generates block noise feature information bclass which indicates the features of the detected block noise, and stores this in the detected data buffer unit 36. Note that the block noise detection processing will be described in detail later with reference to FIG. 17.

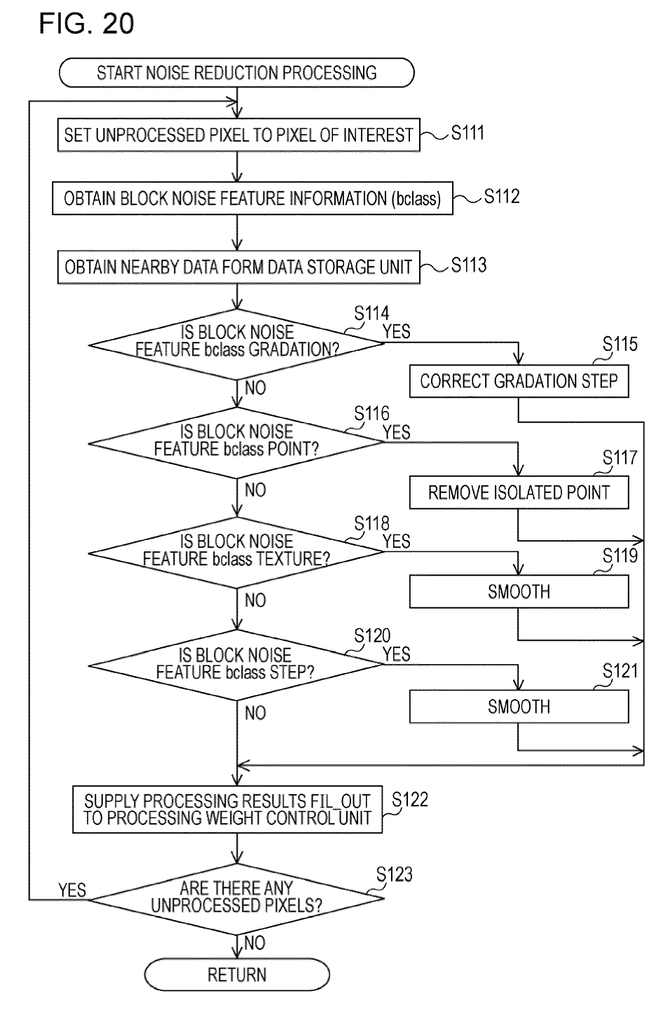

In step S15, the noise reduction processing unit 34 executes noise reduction processing, based on the input image data, position control information, block size information, and block noise feature information, reduces noise for the input image data, and sequentially supplies this as reduced-noise image data FIL_OUT to the processing weight control unit 37. Note that the noise reduction processing will be described in detail later with reference to FIG. 20.

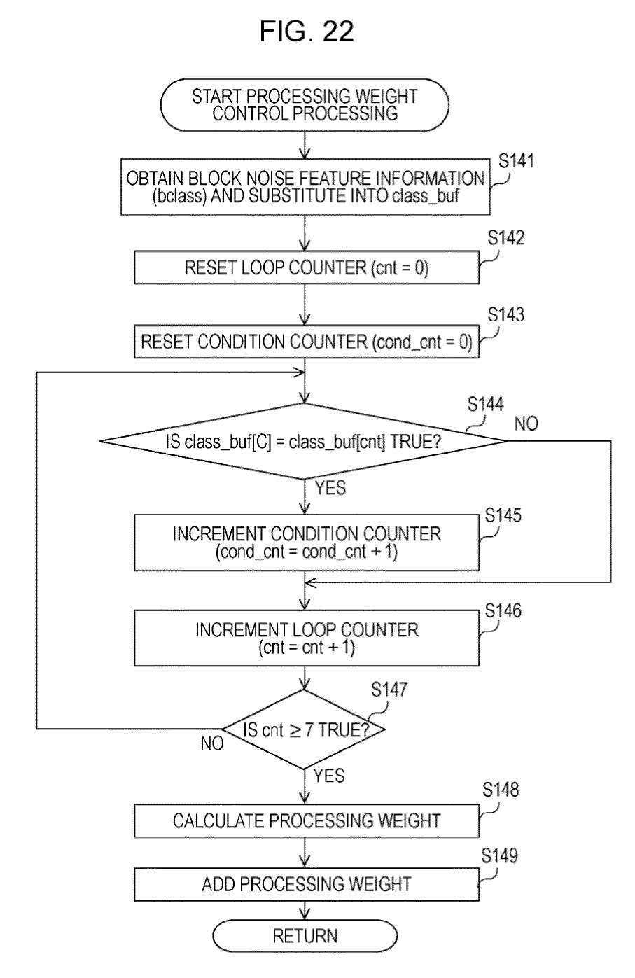

In step S16, the processing weight control unit 37 executes processing weight control processing based on input image data D[x][y], reduced-noise image data FIL_OUT, and block noise feature information, and generates processing weight pwgt, while synthesizing the input image data D[x][y] and reduced-noise image data FIL-OUT based on the processing weight pwgt, generates the processing weight control image data P_OUT, and supplies this to the edge weight control unit 38. Note that the processing weight control processing will be described in detail later with reference to FIG. 22.

In step S17, the edge weight control unit 38 executes edge weight control processing based on the input image data D[x][y], processing weight control image data P_OUT, and edge weight edwgt; synthesizes the input image data D[x][y] and processing-weight-controlled image data P_OUT, based on the edge weight edwgt; generates edge-weight-controlled image data E_OUT, and supplies this to the position weight control unit 39. Note that the edge weight control processing will be described in detail later with reference to FIG. 24.

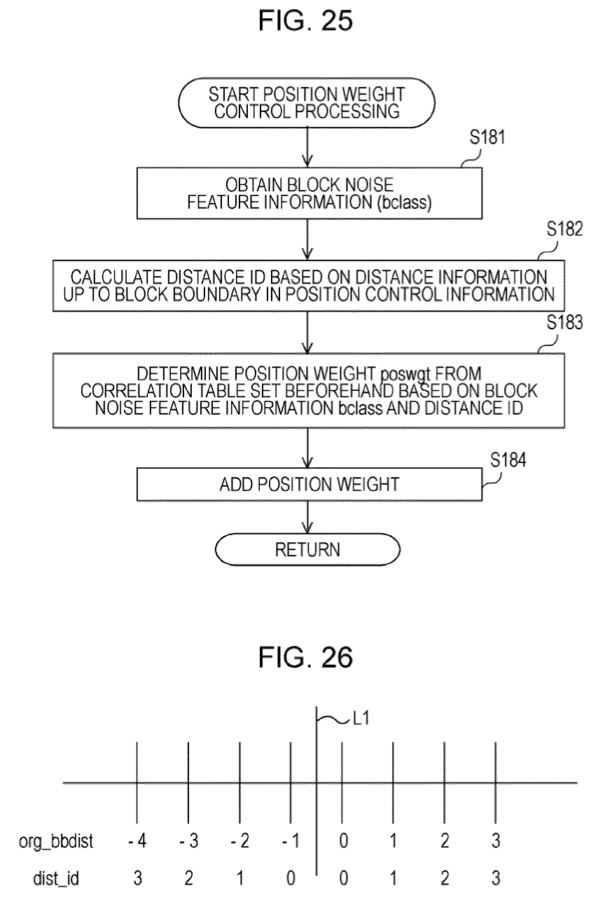

In step S18, the position weight control unit 39 executes position weight control processing based on input image data D[x][y], edge-weight-controlled image data E_OUT, block noise feature information, and position control information, calculates the position weight poswgt, synthesizes the input image data D[x][y] and edge-weight-controlled image data E_OUT, based on the calculated position weight poswgt, to generate the position-weight-controlled image data, and outputs image data subjected to block noise reduction processing. Note that the position weight control processing will be described in detail later with reference to FIG. 25.

With the above-described processing, the input image data has the image thereof appropriately corrected based on the feature information of the block noise of the pixels in the block boundary position, whereby block noise is reduced.

Next, position control information generation processing with the position control unit 31 in FIG. 4 will be described with reference to the flowchart in FIG. 12.

In step S31, the position control unit 31 initializes an unshown control counter cnt (cnt=0).

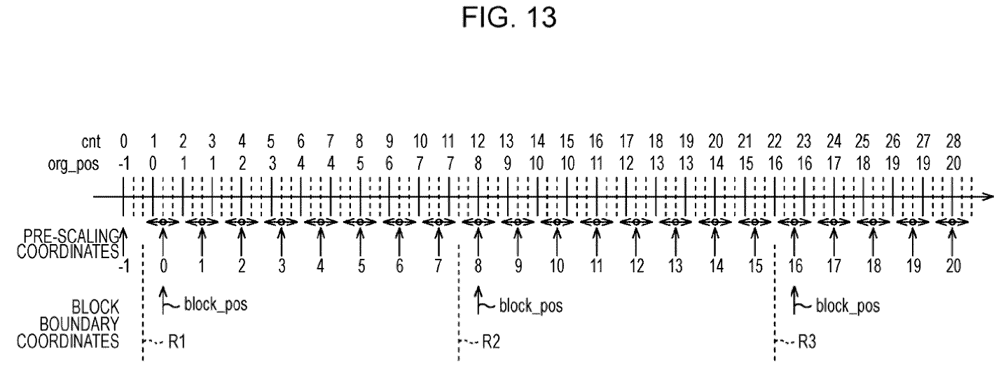

In step S32, the position control unit 31 initializes an unshown position counter pos_cnt (pos_cnt=-block_pos). That is to say, the block boundary position block_pos is a coordinate in the center position of the pixels making up the block boundary in the pre-scaling image data, and as shown in FIG. 13, for example if the coordinates are configured to incrementally increase in the right direction, the block boundary position on the left edge is desirable to have an origin point (=0), whereby the left edge in the coordinate system is offset by the amount of the block boundary position.

Note that FIG. 13 is a diagram describing a coordinate system in the horizontal direction, wherein the uppermost row shows the control counter cnt, the second row shows the coordinates of corresponding pixel positions of the pre-scaling pixels, such that pixel value information is reflected in the pixel position of the post-scaling image data, and the third row indicates the coordinates of the pixel position of the pre-scaling image data. Also, the scale showing the coordinate system shows the minimum spacing to be 16 (minimum increment), and the position of the tick marks shows with solid lines indicate the coordinates of the pixel position of the post-scaling image data.

Accordingly, for example in the case that the block boundary position is 64 from the left edge of the image, the coordinates on the left side in FIG. 2 becomes −64, as shown in the diagram, and when the post-scaling pixel position for the input image data is expressed with the sequential control counter cnt, the corresponding pixel coordinates are expressed sequentially as −64, −16, 32, 80, and so on.

Note that FIG. 14 shows position control information to be described later, corresponding to the control counter cnt, from the top, control counter cnt, position counter pos_cnt, pre-scaling position org_pos, pre-scaling in-block position org_bcnt, pre-scaling distance to boundary org_bbdist, block number to which current position belongs bpos, and the coordinates of the closest block boundary bbpos. Note that the pre-scaling position org_pos, pre-scaling in-block position org_bcnt, pre-scaling distance to boundary org_bbdist, block number to which current position belongs bpos, and the coordinates of the closest block boundary bbpos, will be described in detail later.

In step S33, the pre-scaling position calculating unit 51 obtains the pre-scaling position (of the pixels in the image data) org_pos, that shows to which pixels in the pre-scaling image the position in the input image data expressed with the current control counter cnt corresponds, based on block boundary position and block size information, by calculating the Expression (1) below, and supplies this along with the block boundary position and block size information to the pre-scaling in-block position calculating unit 52.

org_{—}pos=F1[(pos_{—}cnt+32)/64] (1)

F[A] expresses a function which executes a calculation that rounds down the decimal points at and below A.

That is to say, the left edge of the image becomes the left edge of the pixel on the left edge, and when the coordinates are set from the left edge position thereof, the position of the pixel is expressed with the left edge of each pixel as a standard, whereby the center position of the pixels are not expressed as the pixel coordinates. Thus, by offsetting the 32 which is to be the center position as to the 64 which is the pixel size in the pre-scaling image data, the coordinates are converted to have the center position of each pixel as a standard, and further, by dividing by 64 which is the pixel size, and subsequently rounding down the decimal points, information indicating which pixel in the pre-scaling image data each post-scaling pixel corresponds to can be found, as shown in the pre-scaling position org_pos in FIG. 14.

That is to say, for example, as shown in FIGS. 13 and 14, for example, the position counter pos_cnt corresponding to the control counter cnt=0 is —64, and the pre-scaling position org_pos is −1. Also, for example, the position counter pos_cnt corresponding to the control counter cnt=1 is −16, and the pre-scaling position org_pos is 0. Further, for example, the position counter pos_cnt corresponding to the control counter cnt=2 is 32, and the pre-scaling position org_pos is 0.

However, for example, the position counters pos_cnt corresponding to the control counters cnt=2, 3 are −32 and 80, respectively, but the pre-scaling positions org_pos are both 1. That is to say, this indicates that the pre-scaling (pixel) positions org_pos corresponding to the pixels of the control counter cnt=2, 3 both are of the same pixel. This is because for each pixel position in the input image data (the pixel positions in the post-scaling image data), the position counter pos_cnt which is the pixel size in the post-scaling image data changes by 48 (minimum increment) at a time, whereas for the position org_pos that indicates the pre-scaling pixel position, the position counter pos_cnt which is the pixel size changes by 64 (minimum increment) at a time. Thus, there are cases wherein each pixel of the input image data which is the post-scaling image data and each pixel of the corresponding pre-scaling image data do not correspond as 1:1.

Also, as shown in FIG. 13, by being offset by 32, the actual block boundary positions becomes positions R1, R2, R3, and while the pres-scaling block size is 8 pixels, the post-scaling block size becomes 10.666 pixels. Also, the position R1 which is a block boundary position is a pre-scaling position worth one pixel from the left edge of the coordinate system, and so can be said to be at a position of 1.333 times the post-scaling pixel.

In step S34, the pre-scaling in-block position calculating unit 52 obtains the pre-scaling in-block position org_bcnt, that shows to which pixel in the pre-scaling block the position expressed with the current control counter cnt corresponds, by calculating the Expression (2) below, and supplies this along with the pre-scaling position org-pos, the block boundary position and block size information to the boundary distance calculating unit 53. Note that one block here is 8 pixels×8 pixels.

org_{—}bcnt=F2[org_{—}pos/8] (2)

F2[B] expresses a function obtaining a residue calculation of B. That is to say, by calculating Expression (2), the residual of dividing the pre-scaling pixel position by 8 is obtained, whereby one of 0, 1, 2, . . . 7 is obtained as the pre-scaling in-block pixel position, as shown with the pre-scaling in-block position org_bcnt in FIG. 14.

In step S35, the boundary distance calculating unit 53 obtains the distance org_bbdist to the pre-scaling (closest) block boundary position from the position expressed with the current counter cnt by calculating the Expression (3), and supplies this along with the pre-scaling in-block position org-bcnt, pre-scaling position org-pos, the block boundary position, and block size information to the affiliated block number calculating unit 54.

org_{—}bbdist=org_{—}bcnt (org_{—}bcnt≦3) org_{—}bcnt−8 (org_{—}bcnt>3) (3)

That is to say, the distance org_bbdist to the pre-scaling block boundary position is one of 0, 1, 2, or 3 in the case that the pre-scaling in-block position org_bcnt is 3 or less, and in the case that the pre-scaling in-block position org_bcnt is greater than 3, the distance org_bbdist is one of −1, −2, −3, or −4. That is to say, the distance org_bbdist to the pre-scaling block boundary position for each pixel of the post-scaling image data, which is the input image data, is obtained as the number of pixels to the nearest pre-scaling block boundary position, and in the case that the value is a positive value of 0 through 3, the distance to the block boundary existing on the left direction in FIG. 13 is shown, and in the case that the value is a negative value of −1 through −4, the distance to the block boundary existing on the right direction in FIG. 13 is shown. Also, the distance org_bbdist to the pre-scaling block boundary position is shown to be closer to the block boundary position as the absolute value thereof becomes smaller, and farther from the block boundary position as the absolute value thereof becomes greater.

In step S36, the affiliated block number calculating unit 54 obtains a block number bpos that shows to which pre-scaling block the pixel in the position expressed with the current counter cnt belongs, by calculating the Expression (4) below, and supplies the obtained block number bpos along with the distance org_bbdist to the pre-scaling block boundary position, pre-scaling in-block position org_bcnt, pre-scaling position org_pos, the block boundary position and block size information, to the boundary coordinate calculating unit 55.

bpos=F1[(org_{—}pos−org_{—}bbdist)/8] (4)

That is to say, the block here is 8 pixels×8 pixels, so the in-block position org_bbdist is subtracted from the pre-scaling position org_pos, whereby the pixel position to be the block boundary position is obtained, and by dividing by 8, e.g. as shown in FIG. 13, the number of blocks from the left to serve as a standard is obtained, and the affiliated block number bpos is obtained.

In step S37, the boundary coordinate calculating unit 55 obtains the post-scaling coordinate bbpos of the closest block boundary position in the pre-scaling image data, seen from the pixel of the position expressed with the current counter cnt, by calculating the Expression (5) below.

bbpos=(bpos×8×64+block_{—}pos)/block_ratio (5)

That is to say, the affiliated block number bpos is the number of blocks from the left side serving as a standard, as shown in FIG. 13, so 8 which is the number of pixels making up the block and 64 which is the pre-scaling pixel size (minimum increment) are multiplied, and further, the offset block boundary position information is added, whereby the closest block boundary position is obtained as the distance from the left side serving as a standard by the minimum increment, and this is divided by the block size ratio to be the post-scaling pixel size, thereby obtained as the closest block boundary position coordinate bbpos.

In step S38, the boundary coordinate calculating unit 55 correlates the pre-scaling position org_pos, pre-scaling in-block position org_bcnt, distance to the pre-scaling block boundary position org_bbdist, block number bpos, and block boundary position coordinate bbpos, which are obtained by the processing in steps S33 through S37, to the current counter cnt and position counter pos_cnt, and stores this as position control information in the position control information buffer unit 40.

In step S39, the position control unit 31 increments the control counter cnt by 1.

In step S40, the position control unit 31 adds the a block_ratio which shows the post-scaling pixel size to the position counter pos_cnt.

In step S41, the position control unit 31 determines whether or not one line worth of processing has ended, and in the case determination is made that processing has not ended, the flow is returned to step S33. That is to say, the processing in steps S33 through S40 is repeated until one line worth of processing is ended. In the case determination is made in step S41 that one line worth of processing is ended, the position control information generation processing is ended.

With the above-described processing, information to control the position of the pixels and the blocks in the pre-scaling image data for every pixel in the post-scaling image data such as shown in FIG. 14 is generated as position control information, and is stored in the position control information buffer unit 40.

Note that as described above, the processing in the flowchart in FIG. 12 describes one line worth of processing, and in reality, one frame or one field worth of images are processed, so the same processing for the number of lines worth is repeated. Also, only one frame or one field worth of images has to be processed, so an arrangement may be made wherein, not only processing in line increments in the horizontal direction but processing in column increments in the vertical direction may be performed.

Next, edge detection processing by the edge detecting unit 32 will be described with reference to the flowchart in FIG. 15.

In step S61, the edge detecting unit 32 sets one unprocessed pixel from the post-scaling image data as a pixel of interest D[x][y]. Note that D[x][y] shows pixel data of the input image data stored in the data storage unit 35 which is specified with a coordinate x in the horizontal direction and coordinate y in the vertical direction.

In step S62, the current position edge information calculating unit 61 reads a total of 9 pixels, these being the pixel of interest D[x][y], and the pixels adjacent in the horizontal direction, vertical direction, and diagonal directions D[x+1][y], D[x−1][y], D[x][y+1], D[x+1][y+1], D[x−1][y+1], D[x+1][y−1], D[x][y−1], D[x−1][y−1], of the input image data stored in the data storage unit 35, and calculates the Expression (6) below, whereby the current position edge information ed_x, which is edge information of the pixel of interest, is obtained, and supplied to the edge information generating unit 63.

$$ed\_x = ( 2 \times ( \vert D [ x + 1 ] [ y ] - D [ x ] [ y ] \vert + \vert D [ x ] [ y ] - D [ x - 1 ] [ y ] \vert ) + ( \vert D [ x + 1 ] [ y + 1 ] - D [ x ] [ y + 1 ] \vert + \vert D [ x ] [ y + 1 ] - D [ x - 1 ] [ y + 1 ] \vert ) + ( \vert D [ x + 1 [ y - 1 ] ] - D [ x ] [ y - 1 ] \vert + \vert D [ x ] [ y - 1 ] - D [ x - 1 ] [ y - 1 ] \vert ) ) / 8 \qquad ( 6 )$$

That is to say, the current position edge information ed_x in Expression (6) finds the sum of absolute values of the difference between the pixels on the left and right, for the pixel of interest and the pixels above and below, doubles these only for the line of the pixel of interest, adds these together, and divides by 8. Accordingly, if there is any edge between the pixel of interest and the pixels to the top/bottom and the pixels to the left/right thereof, the current position edge information ed_x becomes a large value, and if the image is smooth and there is no edge, the current position edge information ed_x becomes a small value.

In step S63, the boundary position edge information calculating unit 61 reads the nearby block border position bbpos, as seen from the position of the pixel of interest D[x][y], from the position control information buffer unit 40, and reads a total of 9 pixels, these being the corresponding boundary pixel D[b][y], and the pixels adjacent in the horizontal direction, vertical direction, and diagonal directions D[b+1][y], D[b−1][y], D[b][y+1], D[b+1][y+1], D[b−1][y+1], D[b+1][y−1], D[b][y−1], D[b−1][y−1], and calculates the Expression (7) below, whereby the boundary position edge information ed_b which is the edge information of the boundary position pixel is obtained, and supplied to the edge information generating unit 63.

$$ed\_b = ( 2 \times ( \vert D [ b + 1 ] [ y ] - D [ b ] [ y ] \vert + \vert D [ b ] [ y ] - D [ b - 1 ] [ y ] \vert ) + ( \vert D [ b + 1 ] [ y + 1 ] - D [ b ] [ y + 1 ] \vert + \vert D [ b ] [ y + 1 ] - D [ b - 1 ] [ y + 1 ] \vert ) + ( \vert D [ b + 1 ] [ y - 1 ] - D [ b ] [ y - 1 ] \vert + \vert D [ b ] [ y - 1 ] - D [ b - 1 ] [ y - 1 ] \vert ) ) / 8 \qquad ( 7 )$$

That is to say, the boundary position edge information ed_b in Expression (7) finds the sum of absolute values of the difference between the pixels on the left and right, for the boundary pixel and the pixels above and below, doubles these only for the line of the pixel of interest, adds these together, and divides by 8. Accordingly, if there is any edge between the boundary pixel and the pixels to the top/bottom and the pixels to the left/right thereof, the boundary position edge information ed_b becomes a large value, and if the image is smooth and there is no edge, the boundary position edge information ed_b becomes a small value.

In step S64, the edge information generating unit 63 compares the current position edge information ed_x and boundary position edge information ed_b, respectively supplied from the current position edge information calculating unit 61 and boundary position edge information calculating unit 62, and determines whether or not the current position edge information ed_x is greater than the boundary position edge information ed_b.

In the case that the current position edge information ed_x is greater than the boundary position edge information ed_b in step S64, for example, in step S65 the edge information generating unit 63 supplies the current position edge information ed_x as edge information ed_max to the edge weight calculating unit 64.

On the other hand, in the case that the current position edge information ed_x is not greater than the boundary position edge information ed_b in step S64, for example, in step S66 the edge information generating unit 63 supplies the boundary position edge information ed_b as edge information ed_max to the edge weight calculating unit 64.

In step S67, the edge weight calculating unit 64 obtains edge weight edwgt by calculating the Expression (8) below, based on the edge information ed_max supplied from the edge information generating unit 63, correlates this to the pixel position information, and stores this in the edge weight buffer unit 41.

edwgt=0 (ed_max<core) (ed_max−core)/(clip−core)(core≦ed_max<clip) 1 (ed_max≧clip) (8)

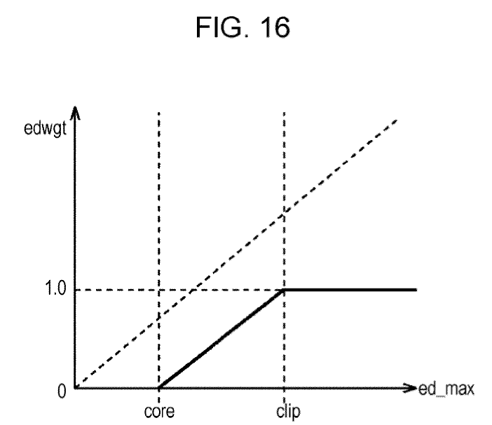

Here, “core” and “clip” are parameters for normalizing the edge weight edwgt in accordance with the relation between the edge weight edwgt and the edge information ed_max shown in FIG. 16. Note that in FIG. 16, the horizontal axis shows edge information ed_max, and the vertical axis shows the values of the edge weight edwgt. That is to say, in the case that the value of the edge information ed_max is smaller than the value set as the “core”, the edge weight edwgt is 0, in the case the value of the edge information ed_max is greater than “core” and smaller than “clip”, the edge weight edwgt is (ed_max−core)/(clip−core), and in the case that the value of the edge information ed_max is greater than “clip”, the edge weight edwgt is set as 1. Consequently, the edge weight edwgt is set as 0 through 1 according to the size of the value of edge information ed_max.

In step S68, the edge detecting unit 32 determines whether or not there are any unprocessed pixels, and in the case any unprocessed pixels exist, the flow is returned to step S61, and the processing in steps S61 through S68 is repeated until determination is made that no unprocessed pixels exist. In the case determination is made that no unprocessed pixels exist in step S68, the flow is ended.

With the above-described processing, in the case that the edge information ed_max, which takes a value that is the greater of the edge strength of the pixel of interest and the edge strength of the boundary pixels near by the pixel of interest, is small, the edge weight edwgt is considered to be 0, and in the case of being greater than “core” and smaller than “clip”, a value wherein the difference between the edge information ed_max and “core” as to the difference between “clip” and “core” is normalized is set as the edge weight edwgt, and in the case the edge information ed_max is greater than “clip”, the edge weight edwgt is set as 1, and weight is set according to the size of the edge information, i.e. corresponding to edge imbalance.

Note that in normalizing the edge weight edwgt, as long as the relation proportional to the monotonous increase of the edge information ed_max is maintained, normalization may be performed that uses not only the relation in FIG. 16; another relation may be used. Also, with Expressions (7) and (8), description is given of an example obtaining the relation with the 8 pixels adjacent to the pixel of interest in the horizontal direction, vertical direction, and diagonal directions, but an arrangement may be made wherein a relation between pixels existing in positions distant from the pixel of interest, proportional to the block size, is used, and for example, a difference between the pixel of interest and 24 pixels existing in a range of 5 pixels×5 pixels with the pixel of interest as the center thereof may be used, or a difference between 16 pixels made up of pixels one pixel apart, excluding the adjacent 8 pixels of the 24 pixels thereof may be used, or further, a difference between the pixel of interest and the pixels distant by a predetermined number of multiple pixels may be used with the pixel of interest as the center.

Next, the block noise detection processing with the block noise detecting unit 33 will be described with reference to the flowchart in FIG. 17.

In step S81, the block noise detecting unit 33 extracts an unprocessed pixel from the input image data stored in the data storage unit 35 and sets this as the pixel of interest.

In step S82, the boundary determining unit 81 reads position control information from the position control information buffer unit 40, and depending on whether the pre-scaling in-block-boundary position org_bcnt is 0, determines whether or not the pixel of interest is at a block boundary position.

In the case that the pixel of interest is not at a block boundary position in step S82, for example, i.e. in the case that the pre-scaling in-block-boundary position org_bcnt is not 0, the processing in steps S83 through S97 is skipped, and the flow is advanced to step S98.

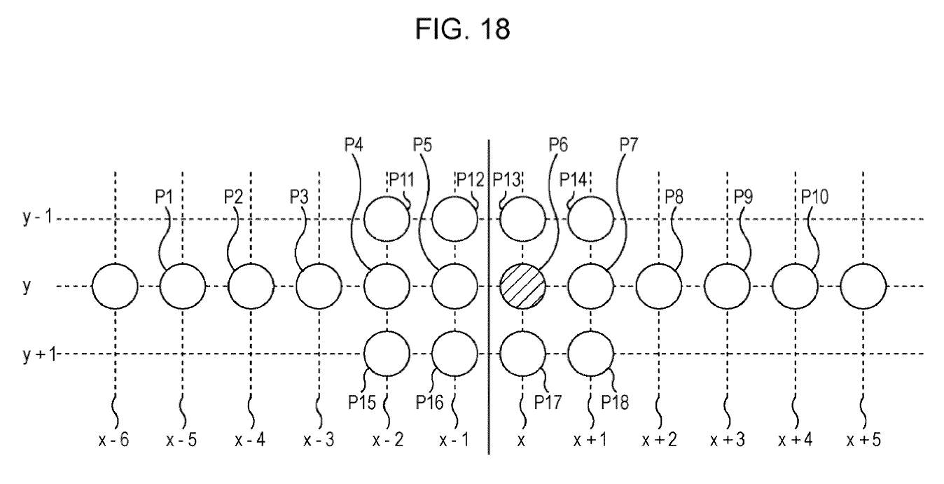

On the other hand, in the case that the pixel of interest is at a block boundary position in step S82, for example, i.e. in the case that the pre-scaling in-block-boundary position org_bcnt is 0, in step S83, the boundary determining unit 81 reads the image data near the pixel of interest from the data storage unit 35, supplies this to the gradation step condition calculating unit 82, isolated point condition calculating unit 85, texture imbalance condition calculating unit 87, and simple step condition calculating unit 89. That is to say, for example as shown in FIG. 18, in the case that the pixel of interest is pixel P6 shown with shading, and this exists in the block boundary L1, for example this is read as a pixel value wherein the pixels P1 through P5 and pixels P7 through P18 are nearby pixels. Note that in FIG. 18, the pixel position of the pixel of interest is expressed as (x, y), and when the pixel of interest P6 is expressed with the above-described D[x][y], the pixels P1 through P18 are respectively expressed as D[x−5][y], D[x−4][y], D[x−3][y], D[x−2][y], D[x−1][y], D[x][y], D[x+1][y], D[x+2][y], D[x+3][y], D[x+4][y], D[x−2][y−1], D[x−1][y−1], D[x][y−1], D[x+1][y−1], D[x−2][y+1], D[x−1][y+1], D[x][y+1], and D[x+1][y+1].

In step S84, the gradation step condition calculating unit 82 calculates the Expressions (9) through (20) below, thereby calculating gradation step condition expressions c_grad 1 through 12, and supplies these to the gradation step condition determining unit 83.

c_grad1=∥P5−P4|−|P6−P5∥ (9)

c_grad2=∥P5−P4|−|P4−P3∥ (10)

c_grad3=∥P7−P6|−|P6−P5∥ (11)

c_grad4=∥P7−P6|−|P8−P7∥ (12)

c_grad5=|P6−P5| (13)

c_grad6=(|P5−P4|+|P4−P3|+|P7−P6|+|P8−P7|)/4 (14)

c_grad7=(P6−P5)×(P3−P2) (15)

c_grad8=(P6−P5)×(P4−P3) (16)

c_grad9=(P6−P5)×(P5−P4) (17)

c_grad10=(P6−P5)×(P7−P6) (18)

c_grad11=(P6−P5)×(P8−P7) (19)

c_grad12=(P6−P5)×(P9−P8) (20)

In step S85, the gradation step condition determining unit 83 obtains the Expressions (9) through (20) which are the gradation step condition expressions c_grad 1 through 12, supplied from the gradation step condition calculating unit 82, and according to these conditions, determines whether or not the gradation step conditions c_grad (the conditions expressed with the conditional expressions expressed with c_grad 1 through 12) satisfy that there is a gradation step.

In greater detail, the gradation step condition determining unit 83 compares the Expressions (21) through (27) below, and determines which of Expressions (21) and (22) are true, and whether Expression (23), and which of Expressions (24) through (27) are true, thereby determining whether these satisfy the gradation step condition c_grad, and determines whether or not there is a gradation step.

c_grad1>c_grad2 (21)

c_grad3>c_grad4 (22)

c_grad5>c_grad6 (23)

c_grad7<0 & c_grad8<0 & c_grad9<0 & c_grad10<0 (24)

c_grad12<0 & c_grad11<0 & c_grad10<0 & c_grad9<0 (25)

c_grad7≧0 & c_grad8≧0 & c_grad9≧0 & c_grad10≧0 (26)

c_grad12≧0 & c_grad11≧0 & c_grad10≧0 & c_grad9≧0 (27)

Note that “&” in Expressions (24) through (27) denotes the logical AND.

That is to say, Expression (21) shows that the change in pixel value between the pixels straddling the block boundary L1 is greater than the change in pixel value on the left side of the block boundary L1 as seen from the pixel of interest P6 in FIG. 18, and conversely, Expression (22) shows that the change in pixel value of the block boundary L1 is greater than the change in pixel value at the right side of the block boundary L1 as seen from the pixel of interest P6 in FIG. 18.

Also, Expression (23) shows that the change in pixel value between pixels straddling the block boundary L1 is adjacent to the block boundary L1 and is greater than the average difference between pixels which do not straddle the block boundary L1.

Further, Expressions (24) through (27) each show a change matching the direction of change between the pixels straddling the block boundary L1 (the direction of whether the pixel tone is sequentially increasing or sequentially decreasing).

In step S85, for example in the case determination is made that the gradation step condition c_grad is satisfied, in step S86, the gradation step condition determining unit 83 supplies the determination results showing that the gradation step condition c_grad is satisfied to the block noise feature determining unit 84 and isolated point condition calculating unit 85. The block noise feature determining unit 84 sets the block noise feature information bclass of the pixel of interest as GRADATION showing a gradation step, based on the determination results herein.

On the other hand, in the case determination is made in step 385 that the gradation step condition c_grad is not satisfied, in step S87 the gradation step condition determining unit 83 supplies the determination results indicating that the gradation step condition is not satisfied to the block noise feature determining unit 84 and isolated point condition calculating unit 85. Based on the determination results herein, the isolated point condition calculating unit 85 calculates the Expressions (28) through (37) below which are isolated point condition expressions c_point 1 through 10, and supplies these to the isolated point condition determining unit 86.

c_point1=(P5−P4)×(P6−P5) (28)

c_point2=(P16−P5)×(P5−P12) (29)

c_point3=(P5−P4)×(P16−P5) (30)

c_point4=MAX[|P5−P12|, |P16−P5|, |P5−P4|, |P6−P5|] (31)

c_point5=MIN[|P5|P12, |P16−P5|, |P5−P4|, |P6−P5|] (32)

c_point6=(P6−P5)×(P7−P6) (33)

c_point7=(P17−P6)×(P6−P13) (34)

c_point8=(P6−P5)×(P17−P6) (35)

c_point9=MAX[|P6−P13|, |P17−P6|, |P6−P5|, |P7−P6|] (36)

c_point10=MIN[|P6−P13, |P17−P6|, |P6−P5|, |P7−P6|] (37)

MAX [A, B, C, D] and MIN [A, B, C, D] show that the maximum value and minimum value of the values in [A, B, C, D] respectively are selected.

In step S88, the isolated point condition determining unit 86 obtains the Expressions (28) through (37) which are isolated point condition expressions c_point 1 through 10 supplied from the isolated point condition calculating unit 85, and according to the condition herein, determines whether or not the expressions satisfy that the isolated point condition c_point is an isolated point.

More specifically, the isolated point condition determining unit 86 compares the Expressions (38) through (47) below, and determines whether all of Expressions (38) through (42) are true, or whether all of Expressions (43) through (47) are true, thereby determining whether the isolated point condition c_point (conditions expressed by isolated point condition expressions c_point 1 through 10) is satisfied.

c_point1<0 (38)

c_point2<0 (39)

c_point3>0 (40)

c_point4≧th1 (41)

(c_point5)/4<c_point4 (42)

c_point6<0 (43)

c_point7<0 (44)

c_point8>0 (45)

c_point9≧th1 (46)

(c_point10)/4<c_point9 (47)

“th1” represents a predetermined threshold.

That is to say, Expression (38) shows that the change direction of the pixel of interest P6 and the pixel P5 which is adjacent thereto straddling the block boundary L1 in FIG. 18, and the change direction between the pixels of pixel P5 and the adjacent pixel P4, do not match, and also Expression (39) shows that the change directions between pixel P5 and the pixels adjacent above and below do not match. Further, Expression (40) shows that the change direction of the pixel P16 which is adjacent in the lower direction to pixel P5 and the change direction of the pixel P4 which is adjacent in the left direction to the pixel P5 is the same. Also, Expression (40) shows that, of the difference absolute values between the pixel P5 and the pixels adjacent in the upper, lower, left, and right directions to pixel P5, the minimum value is greater than the predetermined threshold th1. Further, Expression (41) shows that, of the difference absolute values between the pixels adjacent in the upper, lower, left, and right directions to pixel P5, ¼ of the maximum value is smaller than the minimum value.

On the other hand, expression (43) shows that the change direction of the pixel of interest P6 and the pixel P5 which is adjacent thereto straddling the block boundary L1 in FIG. 18, and the change direction between the pixels of pixel of interest P6 and the adjacent pixel P7, do not match, and also Expression (44) shows that the change directions between the pixel of interest P6 and the pixels adjacent above and below do not match. Further, Expression (45) shows that the change direction of the pixel P17 which is adjacent in the lower direction to pixel of interest P6 and the change direction of the pixel P5 which is adjacent in the left direction to the pixel P6 is the same. Also, Expression (46) shows that, of the difference absolute values between the pixel P6 and the pixels adjacent in the upper, lower, left, and right directions to pixel P6, the minimum value is greater than the predetermined threshold th1. Further, Expression (47) shows that, of the difference absolute values between the pixels adjacent in the upper, lower, left, and right directions to pixel P6, ¼ of the maximum value is smaller than the minimum value.

That is to say, in the case that one of the pixel of interest P6 or the pixel P5 which is adjacent sandwiching the block boundary L1 has a great difference between the adjacent pixel, whereby the change direction does not match, the pixel of interest is viewed as an isolation point.

In step S88, for example, in the case that all of the Expressions (38) through (42) are true, or that all of Expressions (43) through (47) are true, in step S89, the isolated point condition calculating unit 86 supplies the determination results showing that the isolation point condition c_point is satisfied to the block noise feature determining unit 84 and the texture imbalance condition calculating unit 87. The block noise feature determining unit 84 sets the block noise feature information bclass of the pixel of interest as a POINT showing the isolation point, based on the determination results thereof.

On the other hand, in the case that determination is made in step S88 that the isolated point condition c_point is not satisfied, in step S90 the isolated point condition calculating unit 86 supplies the determination results showing that the isolation point condition is not satisfied to the block noise feature determining unit 84 and the texture imbalance condition calculating unit 87. Based on the determination results herein, the texture imbalance condition calculating unit 87 calculates the Expressions (48) through (55) below which are texture imbalance condition expressions c_tex 1 through 8, and supplies these to the texture imbalance condition determining unit 88. Note that the Expressions (48) through (52) are the same as c_grad 1 through c_grad 4, respectively.

c_tex1=∥P5−P4|−|P6−P5∥(=c_grad1) (48)

c_tex2=∥P5−P4|−|P4−P3∥(=c_grad2) (49)

c_tex3=∥P7−P6|−|P6−P5∥(=c_grad3) (50)

c_tex4=∥P7−P6|−|P8−P7∥(=c_grad4) (51)

c_tex5=(P5−P4)×(P6−P5)(=c_grad9) (52)

c_tex6=(P5−P4)×(P4−P3) (53)

c_tex7=(P7−P6)×(P6−P5) (54)

c_tex8=(P7−P6)×(P8−P7) (55)

In step S91, the texture imbalance condition determining unit 88 obtains the Expressions (48) through (55) which are the texture imbalance condition expressions c_tex 1 through 8 that are supplied from the texture imbalance condition calculating unit 87, and according to the conditions therein, determines whether or not the texture imbalance condition c_tex satisfies that there is a texture imbalance.

Specifically, the texture imbalance condition determining unit 88 compares the Expressions (56) through (59) below, and determines whether or not one of the Expressions (56) and (57) is true and Expressions (58) and (59) are true, or whether or not one of the conditions of the Expressions (60) and (61) is true, thereby determining whether or not the texture imbalance condition c_tex is satisfied.

c_tex1>c_tex2 (56)

c_tex3>c_tex4 (57)

c_tex5<0 (58)

c_tex6≧0 (59)

c_tex7<0 (60)

c_tex8≧0 (61)

That is to say, Expression (56) shows that the change in pixel values between the pixels straddling the block boundary L1 as seen from the pixel of interest P5 in FIG. 18 is greater than the change in pixel value on the left side of the block boundary L1, and conversely, Expression (57) shows that the change in pixel value at the block boundary L1 is greater than the change in pixel value on the right side of the block boundary L1 as seen from the pixel of interest P5 in FIG. 18.

Also, Expression (58) shows the change direction of the pixel value between two pixels straddling the block boundary L1, and pixels adjacent to pixels P4 through P6 respectively which exist on the left side of the two pixels, as shown in FIG. 18, and Expression (59) shows the change direction of the pixel value between pixels adjacent to the pixels P3 through PS which are adjacent to the left side by one pixel as to each of the pixels P4 through P5 in Expression (58).

Further, Expression (60) shows the change direction of the pixel value between two pixels straddling the block boundary L1, and pixels adjacent to pixels P5 through P7 respectively which exist on the right side of the two pixels, as shown in FIG. 18, and Expression (61) shows the change direction of the pixel value between pixels adjacent to the pixels P6 through P8 which are adjacent to the right side by one pixel as to each of the pixels P5 through P7 in Expression (60).

In step S91, for example in the case determination is made that the texture imbalance condition c_tex is satisfied, in step S92 the texture imbalance condition determining unit 88 supplies the determination results showing the condition is satisfied to the block noise feature determining unit 84 and the simple step condition calculating unit 89. The block noise feature determining unit 84 sets the block noise feature information bclass of the pixel of interest, as TEXTURE showing texture imbalance wherein pattern component peaks are concentrated, based on the determination results thereof.

On the other hand, in the case determination is made in step S91 that the texture imbalance condition c_tex is not satisfied, in step S93 the texture imbalance condition determining unit 88 supplies the determination results showing the texture imbalance condition is not satisfied to the block noise feature determining unit 84 and the simple step condition calculating unit 89. Based on the determination results thereof, the simple step condition calculating unit 89 calculates the following Expressions (62) and (63) which are simple step condition expressions c_step 1 and 2, and supplies these to the simple step condition determining unit 90.

c_step1=|P6−P5| (62)

c_step2=(|P5−P4|+|P4−P3|+|P3−P2|+|P2−P1|+|P7−P6|+|P8−P7|+|P9−P8|+|P10−P10|)/8 (63)

In step S94, the simple step condition determining unit 90 obtains the Expressions (62) and (63) which are the simple step condition expressions c_step 1 and 2 supplied from the simple step condition calculating unit 89, and according to the conditions herein, determines whether or not the simple step condition c_step satisfies that there is a simple step.

Specifically, the simple step condition determining unit 90 makes a comparison with the Expression (64) below, and determines whether or not the Expression (64) is true, thereby determining whether or not the simple step condition c_step is satisfied.

c_step1>c_step2 (64)

That is to say, Expression (64) shows that the change in pixel value between the pixel of interest P6 in FIG. 18 and the pixels straddling the block boundary L1 is greater than the average change with the 8 pixels in the horizontal direction that straddles the block boundary L1.

In step S94, for example in the case determination is made that the simple step condition c_step is satisfied, in step S95 the simple step condition determining unit 90 supplies the determination results showing that the simple step condition c_step is satisfied to the block noise feature determining unit 84. Based on the determination results herein, the block noise feature determining unit 84 determines the block noise feature information bclass of the pixel of interest as a STEP showing a simple step.

On the other hand, in the case determination is made in step S94 that the simple step condition c_step is not satisfied, in step S96 the simple step condition determining unit 90 supplies the determination results showing that the simple step condition c_step is not satisfied to the block noise feature determining unit 84. Based on the determination results herein, i.e. based on the determination results that there is none of a gradation step, isolated point, texture imbalance, and simple step, the block noise feature determining unit 84 sets the block noise feature information bclass of the pixel of interest as NOT_NOISE indicating that there is no noise.

In step S97, the block noise feature determining unit 84 stores the block feature information bclass which is determined by the processing in one of steps S86, S89, S92, S95, and S96, in the detected data buffer unit 36.

On the other hand, in the case determination is made in step S82 that the pixel of interest is not at a block boundary position, the flow is advanced to step S96. That is to say, in the case determination is made that the pixel of interest is not at a block boundary position, the block noise feature information bclass of the pixel of interest is set to NOT_NOISE indicating that there is no noise.

In step S98, the boundary determining unit 81 determines whether or not there are any unprocessed pixels in the input image data stored in the data storage unit 35, and in the case determination is made that there is an unprocessed pixel, the flow is returned to step S81. That is to say, the processing in steps S81 through S98 is repeated until determination is made that there are no unprocessed pixels. In the case determination is made in step S98 that there are no unprocessed pixels, the flow is ended.

With the above-described processing, of the input image data, the block noise feature information bclass is set for the pixels at the block boundary position, and the set block noise feature information bclass is stored in the detected data buffer unit 36.

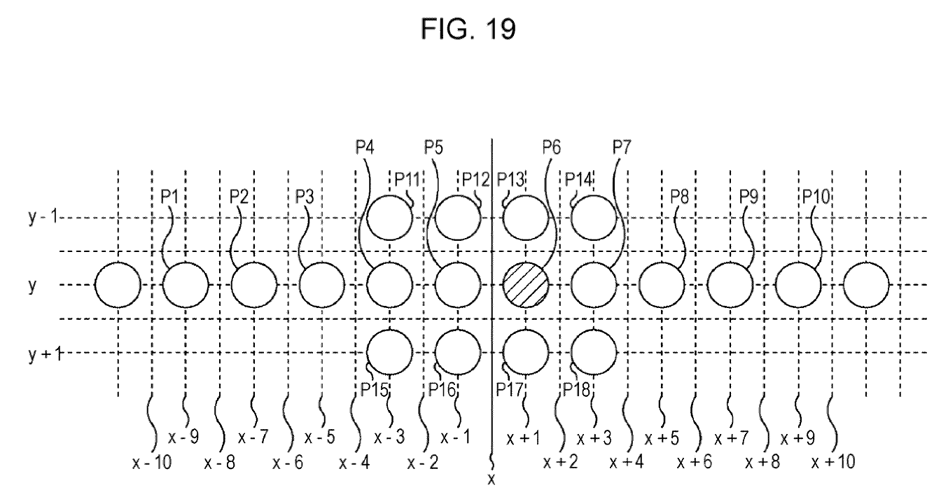

Note that the relations shown in Expressions (9) through (64) show the relative positions in the image in FIG. 18, but this relation stands in the case that the block is less than 16 pixels×16 pixels (greater than 32 with block size ratio), but in the case that the block is greater than 16 pixels×16 pixels (at or less than 32 with block size ratio), e.g. as shown in FIG. 19, the block noise feature information bclass can be detected even when information of an upper range is lost by scaling, by referencing every other pixel in the horizontal direction or the vertical direction.

That is to say, in the case of FIG. 19, the pixels P1 through P18 become D[x−9][y], D[x−7][y], D[x−5][y], D[x−3][y], D[x−1][y], D[x+1][y], D[x+3][y], D[x+5][y], D[x+7][y], D[x+9][y], D[x−3][y−1], D[x−1][y−1], D[x+1][y−1], D[x+3][y−1], D[x−3][y+1], D[x−1][y+1], D[x+1][y+1], D[x+3][y+1] and the block boundary L1 becomes an origin point in the horizontal direction.

Next, the noise reduction processing with the noise reduction processing unit 34 in FIG. 7 will be described with reference to the flowchart FIG. 20.

In step S111, the nearby information obtaining unit 111 sets one of the unprocessed pixels in the input image data as the pixel of interest, and supplies the information of the set pixel of interest to the block noise feature information obtaining unit 112.

In step S112, the block noise feature information obtaining unit 112 obtains the block noise feature information bclass of the pixel of interest from the detected data buffer unit 36.

In step 3113, the nearby information obtaining unit 111 obtains data of the pixel of interest of the input image data and the data of nearby pixels thereof from the data storage unit 35, and supplies this to the gradation step correction unit 113, output unit 114, isolated point removing unit 115, texture smoothing processing unit 116, and simple step smoothing processing unit 117.

In step S114, the block noise feature information obtaining unit 112 determines whether or not the block noise feature information bclass of the pixel of interest is GRADATION which shows a gradation step. In step S114, for example in the case that the block noise feature information bclass of the pixel of interest is GRADATION, showing a gradation step, in step S115 the block noise feature information obtaining unit 112 instructs correcting processing as to the gradation step correction unit 113. Accordingly, the gradation step correction unit 113 corrects the gradation step and outputs the correction results to the output unit 114.

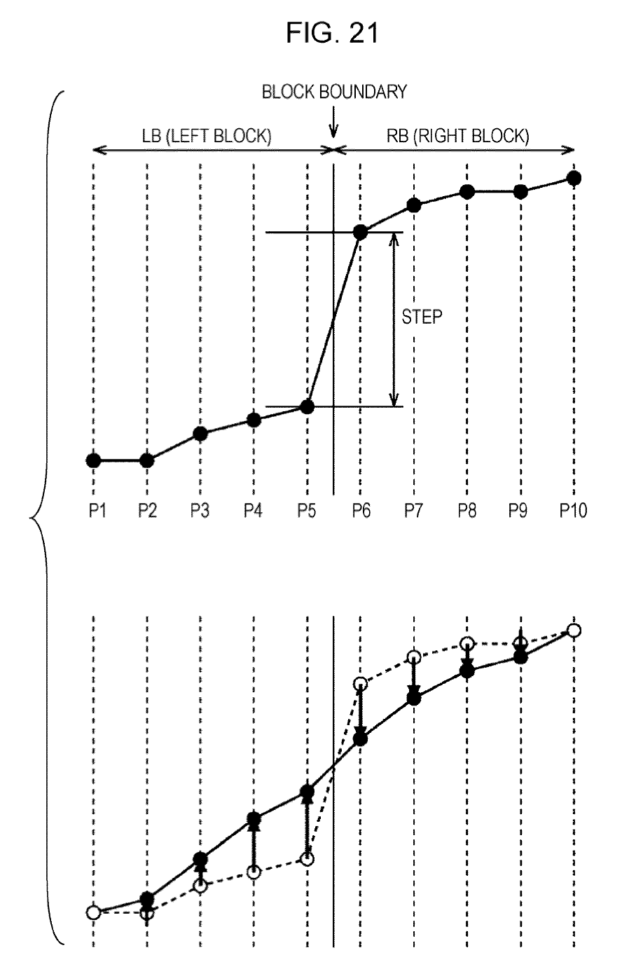

Specifically, the gradation step correction unit 113 controls the step calculating unit 113a to calculate the pixel change at the block boundary closest from the pixel of interest as a “step”. For example, in the case of the upper portion in FIG. 21, the step calculating unit 113a calculates step(=P5−P6) which is the difference between the pixels P5 and P6 that straddle the block boundary L1. Note that in the upper portion of FIG. 21, the pixel values of pixels P1 through P10 in the horizontal direction are shown with the height of the vertical axis, whereby the “step” between the pixels that straddle the block boundary L1 is shown.

The gradation step correction unit 113 controls the correction amount calculating unit 113b to calculate the Expression (65) below, thereby calculating the correction amount of the nearby pixels.

Δ[Px]=−(step×(7−org_{—}bbdist×2))/16 (org_{—}bbdist≧0) (step×(7−|org_{—}bbdist+1|×2))/16 (org_{—}bbdist<0) (65)

A[Px] shows the correction amount of the pixel Px, “step” shows the step calculated by the step calculating unit 113a, and org_bbdist shows the distance to the pre-scaling block boundary position shown in FIG. 17. That is to say, the correction amount calculating unit 113b calculates the Expression (65), thereby calculating the correction amount according to the distance org_bbdist to the pre-scaling block boundary position.

Further, the gradation step correction unit 113 controls the correction processing unit 113c to calculate the following Expression (66), thereby correcting the pixel values.

FIL_OUT=Px+Δ[Px] (66)

FIL_OUT shows reduced noise image data, and Px shows the pixel values of the pixels P1 through P10 in the horizontal direction x of the input image data shown in the upper portion of FIG. 21.

That is to say, the correction processing unit 113c calculates the Expression (66), thereby correcting the pixel values, according to the difference (“step”) of the pixel values between the pixels straddling the nearby block boundary, and the distance from the block boundary (distance org_bbdist), as shown with the dotted lines in the lower portion of FIG. 21. The lower portion of FIG. 21 shows that the pixel values are corrected as to the input image data shown with solid lines with the correction amount according to the distance from the block boundary, as shown with the dotted lines.

Note that description is given here with the example that the pixel value difference between pixels at the block boundary is a “step”, but the change of pixel values between the pixels at the block boundary simply have to be reflected, so an arrangement may be made wherein, for example, instead of pixels at the block boundary position, the difference between the pixels adjacent to such pixels is used to adjust the correction amount. Also, only corrections according to the distance from the block boundary have to be made, so a method other than the above-described method using a “step” may be used, e.g. an arrangement may be made wherein an LPF (Low Pass Filter) is used.

On the other hand, in step S114, for example in the case that the block noise feature information bclass of the pixel of interest is not GRADATION showing a gradation step, in step S116 the block noise feature information obtaining unit 112 determines whether or not the block noise feature information bclass of the pixel of interest is POINT showing an isolated point. In step S116, for example in the case that the block noise feature information bclass of the pixel of interest is POINT showing an isolated point, in step S117 the block noise feature information obtaining unit 112 instructs isolated point removal processing as to the isolated point removing unit 115. Accordingly, the isolated point removing unit 115 uses the isolated point removal correction filter unit 115a to execute isolated point removal, thereby correcting the pixel value, and outputs the correction results to the output unit 114.

Specifically, the isolated point removal correction filter unit 115a is a non-linear filter such as a median filter, and removes the isolated point with a calculation such as that shown in Expression (67) below.

FIL_OUT=MED[D[x−1], D[x], D[x+1]] (67)

MED[A, B, C] is a function to select the middle value of A, B, C. Also, with [D[x−1], D[x], D[x+1]], D[x] shows the pixel value of the pixel of interest and D[x−1], D[x+1] show the pixel values of the pixels adjacent to the left and right of the pixel of interest. Note that the isolated point removal correction filter unit 115a may be realized as an LPF, but by using a median filter the reduction effects can be strengthened more than with an LPF.

On the other hand, in step S116, for example in the case that the block noise feature information bclass of the pixel of interest is not POINT which shows an isolated point, in step S118 the block noise feature information obtaining unit 112 determines whether or not the block noise feature information bclass of the pixel of interest is TEXTURE which shows texture imbalance. In step S118, for example in the case that the block noise feature information bclass of the pixel of interest is TEXTURE which shows texture imbalance, in step S119 the block noise feature information obtaining unit 112 instructs texture smoothing processing as to the texture smoothing processing unit 116. Accordingly, the texture smoothing processing unit 116 uses the texture correction filter unit 116a to execute texture correction processing, thereby correcting the pixel value, and outputting the correction results to the output unit 114.

Specifically, the texture correction filter unit 116a is an LPF, and removes an isolated point with a calculation such as shown in the Expression (68) below.

FIL_OUT=0.25×D[x−1]+0.5×D[x]+0.25×D[x+1] (68)

Note that with Expression (68), description has been given for an example using an LPF with 3 pixels of the pixel of interest and adjacent pixels to the left and right thereof, but an arrangement may be made wherein an LPF using a greater number of pixels is used.

Further, in step S118, for example, in the case that the block noise feature information bclass of the pixel of interest is not TEXTURE which shows texture imbalance, in step S120 the block noise feature information obtaining unit 112 determines whether or not the block noise feature information bclass of the pixel of interest is STEP which shows a simple step. In step S120, for example in the case that block noise feature information bclass of the pixel of interest is STEP which shows a simple step, in step S121 the block noise feature information obtaining unit 112 instructs simple step smoothing processing as to the simple step smoothing processing unit 117. Accordingly, the simple step smoothing processing unit 117 uses the simple step correction filter unit 117a to execute simple step correction processing, thereby correcting the pixel value and outputting the correction results to the output unit 114.

Specifically, the simple step correction filter unit 117a is an LPF, and for example removes an isolated point with a calculation such as shown in the above-described Expression (68).

Note that with the above description, description is given for an example wherein the correction processing as to the simple step and the correction processing as to the texture imbalance is processed with the same LPF, but an arrangement may be made wherein a different LPF is used. Also, an arrangement may be made wherein an LPF with different number of pixels used for the correction processing as to the simple step and the correction processing as to the texture imbalance may be used.

Also, in step S120, e.g. in the case that the block noise feature information bclass of the pixel of interest is not STEP showing the simple step, i.e. in the case that the block noise feature information bclass of the pixel of interest is NOT_NOISE showing that there is no noise, the flow is advanced to step S122.

In step S122, the output unit 114 outputs the pixel value supplied from one of the nearby information obtaining unit 111, gradation step correction unit 113, isolated point removal unit 115, texture smoothing processing unit 116, or simple step smoothing processing unit 117 as reduced noise image data FIL_OUT.

In step S123, the nearby information obtaining unit 111 determines whether or not there are any unprocessed pixels in the input image data, and in the case there are any, the flow is returned to step S111. That is to say, the processing in steps 5111 through S123 is repeated until processing is ended for all of the pixels in the input image data. In the case determination is made in step S123 that there are no unprocessed pixels, the flow is ended.

In other words, in the case that pixel values subjected to correction processing are supplied from one of the gradation step correction unit 113, isolated point removing unit 115, texture smoothing processing unit 116, or simple step smoothing processing unit 117, the output unit 114 outputs the correction results thereof as reduced noise image data FIL_OUT, and of the pixels not subjected to correction, the pixel values supplied from the nearby information obtaining unit 111 is output without change as reduced noise image data FIL_OUT.

With the above-described processing, the noise of each pixel is reduced according to the block noise feature information. Therefore, each pixel is corrected according to the strength and type of noise of the block noise, whereby, as opposed to the case wherein noise is reduced uniformly, problems such as the degree of correction as to strong noise being too weak and noise unable to be sufficiently reduced, or corrections stronger than necessary as to weak noise being performed, and actual image data being lost, can be suppressed, and block noise reduction appropriate to the type of block noise can be realized.

Next, processing weight control processing with the processing weight control unit 37 in FIG. 8 will be described with reference to the flowchart in FIG. 22.

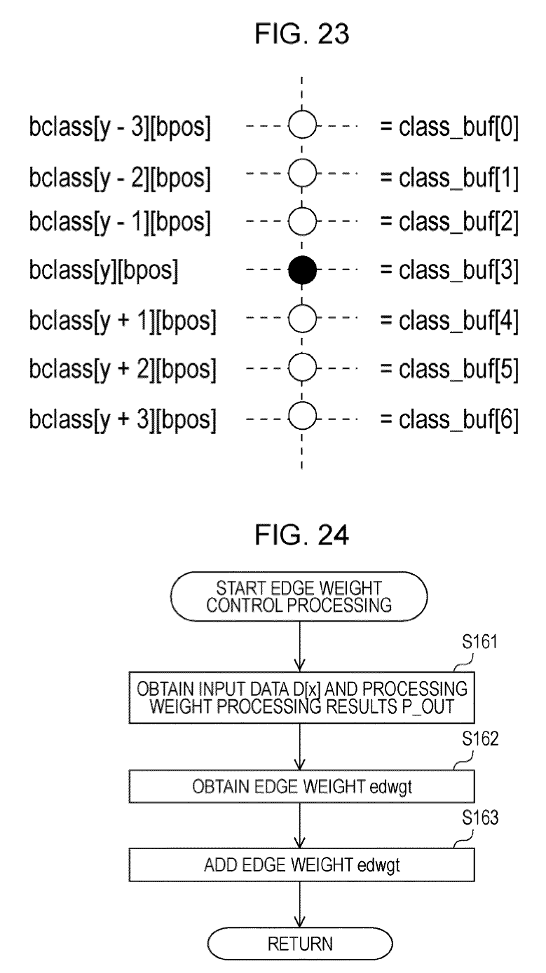

In step S141, the nearby data obtaining unit 131 obtains the reduced noise image data FIL_OUT supplied from the noise reduction processing unit 34, and obtains the corresponding input image data from the data storage unit 35, while also reading the block noise feature information bclass of the nearby pixels corresponding to the reduced noise image data FIL_OUT from the detected data buffer unit 36, and stores this in the buffer unit 132. That is to say, for example, as indicated by the solid circle in FIG. 23, in the case that the block noise feature information of the reduced noise image data FIL_OUT [y][bpos] is expressed as bclass [y][bpos], the nearby data obtaining unit 131 reads the block noise feature information bclass[y−3][bpos], bclass[y−2][bpos], bclass[y−1][bpos], bclass[y+1][bpos], bclass[y+2][bpos], bclass[y+3][bpos] of the pixels belonging to the block of the same block number, disposed in the vertical direction, as the nearby pixels, from the detected data buffer unit 36, and stores this in the buffer unit 132 as block noise feature information class_buf[0] through [6].

In step S142, the processing weight processing unit 37 resets an unshown loop counter cnt to 0, and in step S143 resets an unshown condition counter cond_cnt to 0.

In step S144, the comparing unit 133 compares the block noise feature information class_buf [c]=class_buf [3] corresponding to the block noise feature information of the supplied reduced noise image data FIL_OUT, of the block noise feature information class_buf [0] through [6] of the seven pixels stored in the buffer unit 132, and the block noise feature information class_buf [cnt], and determines whether or not the block noise feature information class_buf [c]=class_buf [3] is the same as the block noise feature information class_buf [cnt].

In step S144, for example in the case determination is made that the block noise feature information class_buf [c]=class_buf [3] is the same as the block noise feature information class_buf [cnt], in step S145 the comparing unit 133 increments the unshown condition counter cond_cnt by 1, and stores this in the comparison results storage unit 134.

In step S146, the comparing unit 133 increments the unshown loop counter cnt by 1.

On the other hand, for example in the case determination is made in step S144 that the block noise feature information class_buf [c]=class_buf [3] is not the same as the block noise feature information class_buf [cnt], the processing in step S145 is skipped.

In step S147, the processing weight control unit 37 determines whether or not the loop counter cnt is 7 or greater which is the number read in to the buffer unit 132 as block noise feature information. In step S147, for example in the case that the number is not 7 or greater, the processing is returned to step 5144. That is to say, determination is made as to whether or not the class_buf [c]=class_buf [3] corresponding to the reduced noise image data FIL_OUT is the same as all of the stored block noise feature information class_buf [0] through [6], and the number that are the same are stored as condition counter cond-cnt in the comparison results storage unit 134.

In the case determination is made in step S147 that the loop counter cnt is 7 or greater which is the number read into the buffer unit 132 as block noise feature information, in step S148 the processing weight calculating unit 135 reads the condition counter cond-cnt stored in the comparison results storage unit 134, calculates the processing weight pwgt, based on the condition counter cond_cnt, and supplies this to the processing weighting unit 136.

Specifically, in the case that the condition counter cond_cnt is greater than half of 7 which is the number of the block noise feature information class_buf [cnt], i.e. in the case that the condition counter cond_cnt is at or greater than 4, the processing weight calculating unit 135 sets the processing weight pwgt as 4, and in the case of not being 4 or greater, the value of the condition counter cond_cnt is set as the processing weight pwgt.

In step S149, based on the processing weight pwgt supplied from the processing weight calculating unit 135, the processing weighting unit 136 synthesizes the reduced noise image data FIL_OUT and the input image data D[x][y], thereby adding the processing weight pwgt, and outputting this to the edge weight control unit 38 as processing weight control image data P_OUT.

Specifically, by calculating the Expression (69) below, the processing weighting unit 136 synthesizes the reduced noise image data FIL_OUT and the input image data D[x][y], thereby adding the processing weight pwgt, and outputting this to the edge weight control unit 38 as processing weight control image data P_OUT.

P_OUT=FIL_OUT×pwgt/4+D[x][y]×(1−pwgt/4) (69)

The more that the block noise feature information of the pixels of the reduced noise image data FIL_OUT supplied with the above-described processing is the same as pixels nearby, the more the processing weight control image data P_OUT with a strong influence from the reduced noise image data FIL_OUT due to processing weight is generated, and conversely, the less that the block noise feature information of the pixels of the reduced noise image data FIL_OUT is the same as pixels nearby, the more the processing weight control image data P_OUT with a strong influence from the input image data is generated.

That is to say, the block noise feature information shows noise feature in block increments, so the probability of having the same information in block increments is high, and the more the information is the same, the reliability of the block noise feature information is increased. Thus, in the case that the nearby pixels include many pixels that have the same block noise feature information, the processing weight pwgt is increased, the processing weight control image is generated so as to increase the synthesis ratio of the reduced noise image data wherein noise is reduced based on the block noise feature information, and conversely, in the case that the nearby pixels include few pixels that have the same block noise feature information, the processing weight pwgt is decreased, the processing weight control image is generated so as to increase the synthesis ratio of the input image data. Thus, the synthesis ratio of the reduced noise image data can be appropriately adjusted according to the block noise strength.

Next, the edge weight control processing with the edge weight control unit 38 in FIG. 9 will be described with reference to the flowchart in FIG. 24.

In step S161, the data obtaining unit 151 obtains the processing weight control image data P_OUT supplied from the processing weight control unit 37, and further supplies the input image data D[x][y] of the pixel position corresponding to the processing weight control image data P_OUT to the edge weighting unit 152.

In step S162, the edge weighting unit 152 reads the edge weight edwgt from the edge weight buffer unit 41 of the position corresponding to the processing weight control image data P_OUT from the edge weight buffer unit 41.

In step S163, the edge weighting unit 152 synthesizes the processing weight control image data P_OUT and the input image data D[x][y], based on the edge weight edwgt, thereby adding the edge weight edwgt, and outputs this as edge weight control image data E_OUT to the position weight control unit 39.

Specifically, by calculating the Expression (70) below, the edge weighting unit 152 synthesizes the processing weight control image data P_OUT and the input image data D[x][y], thereby adding the edge weight edwgt, and outputs this as edge weight control image data E_OUT to the position weight control unit 39.

E_OUT=P_OUT×edwgt+D[x][y]×(1−edwgt) (70)

The greater the edge weight edwgt of the processing weight control image data P_OUT supplied from the above-described processing is, the more the edge weight control image data E_OUT with a strong influence from the processing weight control image data P_OUT is generated, and conversely, the smaller the edge weight edwgt is, the more the edge weight control image data E_OUT with a strong influence from the input image data is generated.

Next, position weight control processing with the position weight control unit 39 in FIG. 10 will be described with reference to FIG. 25.

In step S181, based on the position of the edge control image data E_OUT supplied from the edge weight control unit 38, the data obtaining unit 171 obtains the block noise feature information bclass of the corresponding position from the detected data buffer unit 36, while obtaining the position control information, and supplies the block noise feature information bclass to the position weight calculating unit 173, and supplies the position control information and edge control image data E_OUT to the distance ID calculating unit 172.

In step S182, the distance ID calculating unit 172 calculates the Expression (71) below, based on the distance org_bbdist to the pre-scaling block boundary position at the position control information, thereby calculating the distance ID dist_id, and supplies this to the position weight calculating unit 173.

dist_{—}id=org_{—}bbdist (org_{—}bbdist≧0) |1+org_{—}bbdist| (org_{—}bbdist<0) (71)

In other words, as shown in FIG. 26, with the distance ID calculating unit 172, the distance ID according to the distance from the block boundary L1 is set; the pixels 0, −1 expressed with the distance org_bbdist to the block boundary position is calculated with the distance ID being dist_id=0; the pixels 1, −2 expressed with the distance org_bbdist to the block boundary position is calculated with the distance ID being dist_id=1; the pixels 2, −3 expressed with the distance org_bbdist to the block boundary position is calculated with the distance ID being dist_id=2; and the pixels 3, −4 expressed with the distance org_bbdist to the block boundary position is calculated with the distance ID being dist_id=3.

In step S183, the position weight calculating unit 173 calculates the position weight poswgt referencing the table 173a, based on the block noise feature information bclass and the distance ID, and supplies this to the position weighting unit 174.

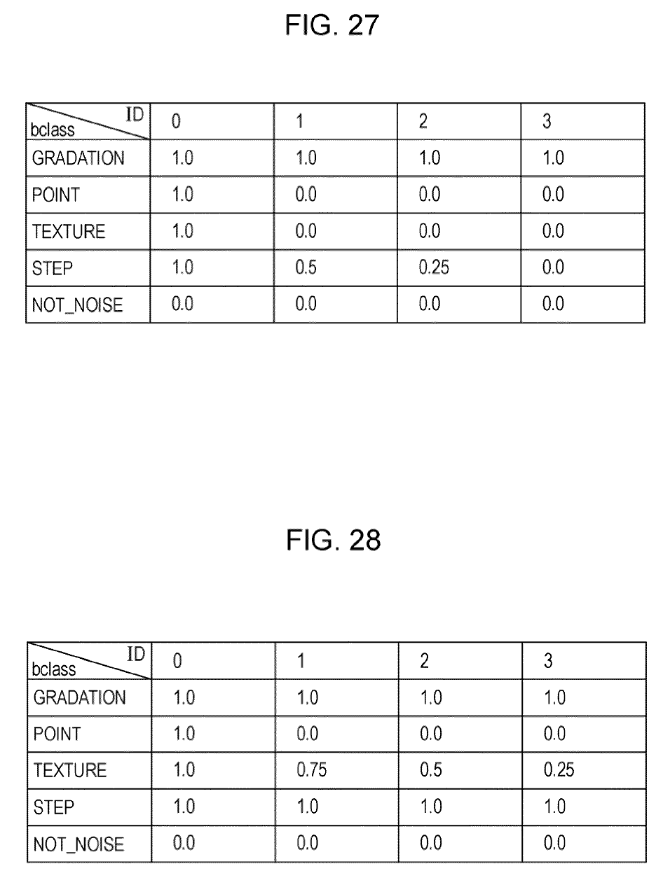

The position weight poswgt is set in the table 173a, made up of a combination of the block noise feature information bclass and distance ID, as shown in FIG. 27, for example. That is to say, in FIG. 27, in the case that the block noise feature information bclass is GRADATION which shows a gradation step, when the distance ID is 0 through 3, the position weight poswgt is set to 1.0; in the case that the block noise feature information bclass is POINT which shows an isolated point, or in the case of TEXTURE which shows texture imbalance, when the distance ID is 0, the position weight poswgt is set to 1.0, and when the distance ID is 1 through 3, the position weight poswgt is set to 0.0, in the case that the block noise feature information bclass is STEP which shows a simple step, when the distance ID is 0, the position weight poswgt is set to 1.0, when the distance ID is 1, the position weight poswgt is set to 0.5, when the distance ID is 2, the position weight poswgt is set to 0.25, and when the distance ID is 3, the position weight poswgt is set to 0.0; and further, in the case that the block noise feature information bclass is NOT_NOISE which shows that there is no noise, when the distance ID is 0 through 3, the position weight poswgt is set to 0.0.

That is to say, the gradation step which is influenced in a wide range by the block noise has a position weight poswgt set with a large weight regardless of the distance. Also, the isolated point and texture imbalance, being local block noise, have a large weight set only for the positions closest to the block boundary position, and do not have weighting for the distant positions. Further, the simple step block noise has a small weight set according to the distance from the block boundary position.

In step S184, by calculating the Expression (72) below as to the input image data D[x][y] and edge weight control image data E_OUT, the position weighting unit 174 adds position weighting, and outputs this as block noise reduction image data.

OUT=(E_OUT×poswgt+(1−poswgt)×D[x][y]) (72)

That is to say, the greater the position weight poswgt is, the more that an image with greater influence from the edge weight control image data will be generated, and conversely, the smaller the position weight poswgt, the more the input image data before correction will be output without change.

With the above-described processing, the distance from the block boundary position, i.e. the weight according to the position within the block is set, and the input image data is corrected.

Note that the control effects from position weight may be increased, and in such a case, for example an arrangement may be made wherein the settings in the table 172a are changed, or for example the settings as shown in FIG. 28 may be used. That is to say, in FIG. 28, as compared to the example shown in FIG. 27, in the case that the block noise feature information bclass is TEXTURE which shows texture imbalance, and in the case of STEP which shows a simple step, the settings differ. Specifically, in FIG. 28, in the case that the block noise feature information bclass is TEXTURE which shows texture imbalance, when the distance ID is 0 through 3, the weights are respectively set as 1.0, 0.75, 0.5, and 0.25, and the weight is set so as to gradually decrease according to the distance from the block boundary L1. Also, in FIG. 28, in the case that the block noise feature information bclass is STEP which shows a simple step, when the distance ID is 0 through 3, the weights are uniformly set as 1.0, and the weight is large regardless of the distance from the block boundary L1.

Also, depending on the degree of block noise distortion, a stronger or weaker block noise reduction effect may be desirable. For example, in order to strengthen the reduction effect, the block noise detecting condition with the block noise detecting unit 33 can be loosened so as to detect only simple step conditions, thereby creating a state wherein block noise is readily detected. Also, in order to strengthen the reduction effect with the noise reduction processing unit 34, an arrangement may be made wherein the number of pixels used for an LPF are set as 7 pixels or so, for example, thereby switching to an LPF with a stronger effect. Further, the edge determining conditions with the edge detecting unit 32 may be loosened to perform reduction processing as to even stronger edges. Also, by weighting more strongly with the position weight control unit 39, e.g. with many conditions shown in FIG. 27 or FIG. 28, the position weight calculation conditions may be changed so as to have a greater effect of reduction processing in a wider range. Further, reduction effects can be further strengthened by performing all of these.

Also, in the case of desiring to weaken the block noise reduction effect, the reduction effect can be weakened by performing adjustments in the opposite of the above description.

Thus, the noise block reduction effects can be flexibly changed as suitable.

Further, with the above description, processing in the horizontal direction has been described as an example, but by simply changing the processing direction by 90 degrees, similar processing can be applied in the vertical direction also. Also, by executing the processing in each of the horizontal direction and vertical direction in order, not only block noise in vertical line form, but also block noise in horizontal line form can be reduced.

According to the present invention, even in the case that the block boundary position is converted to various sizes by scaling, the block noise can be effectively reduced. Also, an optimal reduction method can be selected and applied as to various block noise distortion amounts.

The above-described series of image processing can be executed with hardware hut can also be executed with software. In the case of executing the series of processing with software, a program making up such software is installed in a computer built into dedicated hardware, or in a general-use personal computer which can execute various types of functions by installing various types of programs, from a recording medium.

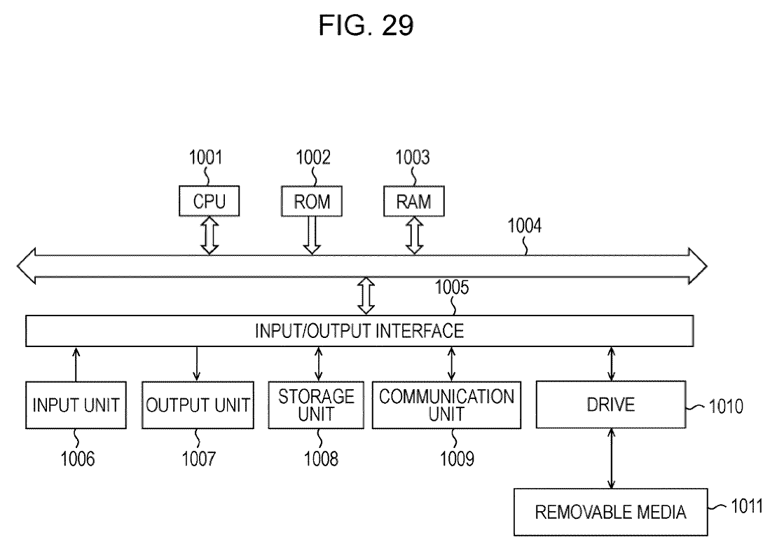

FIG. 29 shows a configuration example of a general-use personal computer. The personal computer herein has a CPU (Central Processing Unit) 1001 built therein. An input/output interface 1005 is connected to the CPU 1001 via a bus 1004. ROM (Read Only Memory) 1002 and RAM (Random Access Memory) 1003 are connected to the bus 1004.

The input/output interface 1005 is connected to an input unit 1006 made up of an input device such as a keyboard, mouse, and the like for a user to input operating commands, an output unit 1007 to output an image of a processing operating screen or processing results to a display device, a storage unit 1008 made up of a hard disk drive or the like that stores a program and various types of data, a communication unit 1009 to execute the communication processing via the network represented by the Internet, by a LAN (Local Area Network) adapter or the like. Also, a drive 1010 is connected which reads/writes data from/to removable media 1011 such as a magnetic disk (including a flexible disk), optical disc (including a CD-ROM (Compact Disc-Read Only Memory) and DVD (Digital versatile Disc)), magneto-optical disk (including a MD (Mini Disc)), and semiconductor memory.

The CPU 1001 executes various types of processing according to the program that is stored in the ROM 1002, read from the removable media 1011 such as a magnetic disk, optical disk, magneto-optical disk, or semiconductor memory and installed in the storage unit 1008, and loaded from the storage unit 1008 to the RAM 1003. Data necessary for the CPU 1001 to execute various types of processing is stored as appropriate in the RAM 1003.

Note that in the present Specification, it goes without saying that the steps describing the program recorded in the recording medium include processing performed in a time-series manner along the described sequence, but also includes processing executed, not necessarily in a time-series manner, but also in parallel or individually.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device configured to reduce noise of an image, comprising:
position control information generating means configured to calculate a block boundary position for each of blocks and the distance of each pixel from the block boundary position, based on block size information and block boundary initial position, and generate position control information of said pixels;
block noise detecting means configured to detect block noise feature information at said block boundary position, based on said position control information; and
noise reduction processing means configured to reduce noise for each of said blocks, based on said block noise feature information.

2. The image processing device according to claim 1, further comprising:
pixel of interest edge detecting means configured to detect a pixel of interest edge of a pixel of interest in said image;
boundary edge detecting means configured to detect a boundary edge of a block boundary near said pixel of interest;
edge weight calculating means configured to calculate edge weight that controls the strength of reduction in said noise, based on said pixel of interest edge and said boundary edge;
processing weight calculating means configured to calculate processing weight to control the strength of reduction in said noise, based on said block noise feature information;
position weight calculating means configured to calculate position weight to control the strength of noise reduction processing, based on position information from said block boundary;
edge weight control means configured to control said pixel of interest based on said edge weight;
processing weight control means configured to control said pixel of interest based on said processing weight; and
position weight control means configured to control said pixel of interest based on said position weight.

3. The image processing device according to claim 2, wherein said pixel of interest edge detecting means and boundary edge detecting means switch the range of pixels used to detect said pixel of interest edge and boundary edge, based on said block size information, respectively.

4. The image processing device according to claim 1, wherein the block size of said image is specified as a scaling ratio from a predetermined block size;
and wherein said block boundary initial position is specified with an accuracy of less than a pixel.

5. The image processing device according to claim 1, said block noise detecting means further comprising:
step determining means configured to determine whether or not said block noise feature information is a step, based on comparison results between a step between pixels at said block boundary position and the average step between periphery pixels around said block boundary position;
wherein said block noise feature information is detected as a simple step, based on the step determining results of said step determining means.

6. The image processing device according to claim 1, said block noise detecting means further comprising:
step determining means configured to determine whether or not said block noise feature information is a simple step, based on comparison results between a step between pixels at said block boundary position and the average step between periphery pixels around said block boundary position;
gradation step means configured to determine whether or not, based on comparison results of a slope of a periphery position of said block boundary position, the periphery portion has the overall same slope, thereby determining whether or not the periphery portion is a gradation step;
isolated point determining means configured to determine, at said block boundary position, whether or not a block noise feature of said block to which said pixel of interest belongs is an isolated point, based on a comparison between the difference of said pixel of interest and the peripheral pixels around said pixel of interest and a predetermined threshold, and on a combination of positive/negative signs of said difference; and
texture determining means configured to determine, at said block boundary position, whether or not said block noise feature is texture imbalance wherein pattern component peaks are collected, based on a combination of positive/negative signs of said difference;
wherein said block noise feature information is detected based on the determination results of said step determining means, said gradation step means, said isolated point determining means, and texture determining means.

7. The image processing device according to claim 6, said noise reduction means further including:
step correcting means configured to correct a step at said block boundary position according to the distance from said block boundary position to said pixel of interest
in the case that said block noise feature information is a gradation step;
removal correcting means configured to remove said isolated point and perform correction at said block boundary position
in the case that said block noise feature information is said isolated point;
first smoothing means configured to smooth the block that includes said pixel of interest at said block boundary position
in the case that said block noise feature information is said texture imbalance; and
second smoothing means configured to smooth the block that includes said pixel of interest at said block boundary position, with a different strength than used with said first smoothing means
in the case that said block noise feature information is said simple step.

8. The image processing device according to claim 1, wherein said block noise feature information detecting means can select nearby pixels to use for detecting, based on said block size information.

9. The image processing device according to claim 1, wherein said noise reducing means switches reduction processing, based on said block size information.

10. An image processing method of an image processing device configured to reduce noise of an image, comprising the steps of:
position control information generating arranged to calculate a block boundary position for each of blocks and the distance of each pixel from the block boundary position, based on block size information and block boundary initial position, and generate position control information of said pixels;
block noise detecting arranged to detect block noise feature information at said block boundary position, based on said position control information; and
noise reduction processing arranged to reduce noise for each of said blocks, based on said block noise feature information.

11. A program to cause a computer to execute control of an image processing device configured to reduce noise of an image, comprising the steps of:
position control information generating arranged to calculate the block boundary position and the distance of each pixel from a block boundary position for each of blocks, based on block size information and block boundary initial position, and generate position control information of said pixels;
block noise detecting arranged to detect block noise feature information at said block boundary position, based on said position control information; and
noise reduction processing arranged to reduce noise for each of said blocks, based on said block noise feature information.

12. A program storage medium configured to store the program according to claim 11.

13. An image processing device configured to reduce noise of an image, comprising:
a position control information generating unit configured to calculate a block boundary position for each of blocks and the distance of each pixel from the block boundary position, based on block size information and block boundary initial position, and generate position control information of said pixels;
a block noise detecting unit configured to detect block noise feature information at said block boundary position, based on said position control information; and
a noise reduction processing unit configured to reduce noise for each of said blocks, based on said block noise feature information.
